(19) United States
(12) Patent Application Publication
(10) Pub. No.: US 2020/0372481 A1
(43) Pub. Date: Nov. 26, 2020

(54) RECURSIVELY CALCULATED ROYALTIES FOR DYNAMICALLY ASSEMBLED DIGITAL CONTENT

(71) Applicant: SparxTeq, Inc., Orem, UT (US)

(72) Inventor: Dan Reed Olsen, JR., Orem, UT (US)

(21) Appl. No.: 16/880,980

(22) Filed: May 21, 2020

Related U.S. Application Data
(60) Provisional application No. 62/851,562, filed on May 22, 2019.

(51) Int. Cl. G06Q 20/12; G06Q 20/22; G06Q 50/18; G06Q 50/20

(52) U.S. Cl. CPC G06Q 20/1235; G06Q 20/29; G09B 7/00; G06Q 50/205; G06Q 50/184

(57) ABSTRACT

Systems and methods are described herein to display and manage royalty distributions for electronic book (eBooks) assembled from multiple instructional units owned by a plurality of owners. In various embodiments, a curation fraction value (CFV) subsystem may calculate a CFV for an assembly owner of the assembled eBook. An owner value profile (OVP) subsystem may generate an OVP data object for the assembled eBook that associates each identified unit owner with a value sum, based on computed value units of the instructional units owned by each respective unit owner. A royalty distribution subsystem may compute a distribution of royalties to the assembly owner and the various unit owners. A share of the royalty for a unit owner may be recursively sub-divided for distribution to nested assembly owners and nested unit owners when one of the instructional units is itself an eBook formed from multiple nested instructional units.

### RELATED APPLICATIONS

This application claims priority to U.S. Provisional Patent Application No. 62/851,562, titled “Systems and Methods for Education” filed on May 22, 2019, which is hereby incorporated by reference in its entirety.

### TECHNICAL FIELD

This disclosure relates to educational instruction, automated grading, and royalty distributions for digital content.

### BRIEF DESCRIPTION OF THE DRAWINGS

This disclosure includes illustrative embodiments that are non-limiting and non-exhaustive. Reference is made to certain of such illustrative embodiments that are depicted in the figures described below.

FIG. 1 illustrates an example of a computing system to manage royalty distributions, according to various embodiments.

FIG. 2A illustrates an example of an electronic book (eBook) with multiple instructional units, according to one embodiment.

FIG. 2B illustrates the example eBook of FIG. 2A with unit values associated with each of the instructional units based on the total number of words in each of the instructional units.

FIG. 2C illustrates the example eBook of FIGS. 2A and 2B with fractional share allocations based on a curation fraction value (CFV) for the curator of the eBook and owner fraction profiles (OFPs) for the owner of each instructional unit.

FIG. 3A illustrates an example of an eBook curated by an assembly owner that includes a nested eBook with additional instructional units owned by different owners.

FIG. 3B illustrates fractional share allocations for the eBook in FIG. 3A based on CFV values for the assembly owner of the eBook and a first level of OFPs for the unit owners of each of instructional units, according to one embodiment.

FIG. 4A illustrates an example of an eBook with an instructional unit that includes a nested eBook with nested instructional units owned by various owners.

FIG. 4B illustrates fractional share allocations for the eBook and the multi-owner nested eBook in FIG. 4A.

FIG. 4C illustrates fractional share allocations for the eBook in FIG. 4A based on time-based usage metrics, according to one embodiment.

FIG. 4D illustrates fractional share allocations for the eBook in FIG. 4A based on an open-tracking usage metric, according to one embodiment.

FIG. 5A illustrates an example of an interactive user interface for presenting a video annotation instructional unit soliciting student answers in the form of markers, according to one embodiment.

FIG. 5B illustrates the interactive user interface of FIG. 5A with student answers from a single student, according to one embodiment.

FIG. 5C illustrates the interactive user interface displaying student answers from multiple students to a grader, according to one embodiment.

FIG. 5D illustrates the interactive user interface facilitating the creation of grade rules for automatic application to student answers markers, according to one embodiment.

FIG. 5E illustrates the interactive user interface with remaining ungraded student answer markers after automatic application of the created grade rules, according to one embodiment.

FIG. 6 illustrates an example of a rich string encoding and a possible presentation, according to one embodiment.

FIG. 7 illustrates a rich string tree representation of the rich string from FIG. 1, according to one embodiment.

FIG. 8 illustrates some examples of types of string index references, according to one embodiment.

FIG. 9 illustrates a table of various relationships for comparing two references.

FIG. 10 illustrates the presentation of a string with a selection encoded as a string location reference, according to one embodiment.

FIG. 11 illustrates an example of a text annotation instructional unit with a segment of text and markers for answer questions, according to one embodiment.

FIG. 12 illustrates an example table of range relationships to define the applicability of grader answers to student answers, according to one embodiment.

FIG. 13 illustrates an example of a graphical user interface (GUI) for a teacher or another grader to specify grade rules in terms of feedback and relationship applicability, according to one embodiment.

### DETAILED DESCRIPTION

The provisional patent application to which this application claims priority, and which is incorporated herein by reference in its entirety, describes systems and methods for improving education. At a high level, the proposed systems and methods in the provisional patent application outline an educational approach that utilizes carefully measured student outcomes and effort to engineer course curriculums to increase learning efficiency and achieve target educational outcomes. The process described therein suggests that teachers adapt course curriculum with relative frequency. As described below, the financial models of traditional textbook creation limit the practicality of adapting or engineering a course curriculum based on measured outcomes.

The systems and methods described herein allow for the remuneration of content creators via a computer-based royalty calculation of dynamically assembled digital content. In some embodiments, the systems and methods allow for the recursive evaluation of digital content to identify and allocate royalties to the creators and curators of content items. Details, examples, and variations of the systems and methods are described below in the context of traditional course creation.

It is quite rare that a teacher creates a course completely from scratch. The process usually begins with the selection of a textbook or textbooks. For more advanced classes, the course creation process may begin with a selection of research papers to be read by the students. In most instances, it is not economical or practical for a single teacher to produce a customized course curriculum from scratch, much less multiple different course curriculums for any number of classes that may each have dozens or even hundreds of students. Textbooks are a mechanism for amortizing the required creativity across numerous courses and teachers involved in teaching thousands of students each year.

While many teachers may adopt the same textbook for teaching their respective courses, it is highly likely that each teacher will not follow the textbook exactly as written. Rather, each teacher may create uniquely omit some chapters or sections, supplement additional material, and/or reorder content from the textbook. Especially in higher education, teachers exhibit a high level of creativity in course creation and adaptation, but still utilize significant portions of textbooks, research papers, and other content (digital or otherwise) created by others.

In many instances, a teacher may create (e.g., write) new material to supplement a selected textbook. Universities and colleges catering to this course creation process provide copy centers specializing in the production and distribution of such materials. Increasingly, digital adaptations, combinations, and portions of textbooks and other content that is curated and assembled by a teacher are made available via class websites and learning management systems.

The process of creating, publishing, and marketing textbooks is relatively ridged, even with the increasing popularity of digital textbooks. Prices for online textbooks are high to protect the economics of traditional book creation. It is generally not practical or efficient to release a new edition of a textbook until the costs of print runs (physical and digital) for previous editions have been recovered. Thus, the traditional update cycle for hardcopy textbooks and even for digital textbooks occurs very slowly—often taking 5-10 years between editions, if new editions are released at all.

As outlined above and described in greater detail in the provisional patent application to which this application claims priority, improved teaching and learning may involve adapting, engineering, and re-engineering curriculum in response to measured learning outcomes. The traditional financial model associated with creating, publishing, advertising, and distributing textbooks, including for both physical and digital textbooks, makes it difficult or impossible for teachers to continually adapt their curriculum in response to measured learning outcomes. In short, the current financial remuneration model for creating, publishing, advertising, and distributing physical and digital textbooks is not fast enough. Moreover, since textbooks rarely have more than two or three authors, the diversity of ideas that can be creatively applied to a course via a traditional physical or digital textbook is also severely limited.

In some embodiments of the presently described systems and methods, a marketplace of teacher-created content is made available within a learning management system. Students can directly purchase units of the available content, and a portion of the proceeds is paid to the teacher that created the purchased content. Examples of such content may include individual or sets of videos and/or questions. In other instances, the content may include an entire multicourse curriculum. In various embodiments, students may purchase and pay for only the content they want.

In some embodiments, other teachers may adopt materials at any level of granularity that they may choose to selectively curate and assembly a customized course curriculum. Thus, a teacher may dynamically mix and match content created by any number of other teachers to develop a course curriculum. The teacher may subsequently remove, add, or substitute portions of the content in response to measured learning outcomes to dynamically adapt their personally curated course curriculum.

A specific example of a curriculum for a physics class is described below to facilitate a clear understanding of one specific embodiment but is not intended to limit or constrain the systems and methods described herein in any way. Four initial teachers may each create portions of a course curriculum for a physics class. A first initial teacher may create a first instructional unit with text describing the first law of thermodynamics and a second instructional unit with a video illustrating an example of the first law of thermodynamics. The second initial teacher may create a third instructional unit with a set of challenge problems relating to the first law of thermodynamics. A third initial teacher may create a fourth instructional unit with text describing the first law of thermodynamics, a fifth instructional unit with text describing the second law of thermodynamics, and a six instructional unit with text describing the third law of thermodynamics. The fourth initial teacher may create seventh, eighth, and ninth instructional units that include diagrams illustrating the principles of the first, second, and third laws of thermodynamics, respectively.

A first curating teacher may assemble a course curriculum for the three laws of thermodynamics that includes the fourth instructional unit, the second instructional unit, the fifth instructional unit, the sixth instructional unit, and the ninth instructional unit. The first curating teacher may create a tenth instructional unit that includes a video summarizing the three laws of thermodynamics and an eleventh instructional unit that includes a set of challenge problems relating to all three laws of thermodynamics.

The first curating teacher may make the assembled course curriculum from the four initial teachers with the additional tenth and eleventh instructional units available to other teachers. A second curating teacher may adopt the course curriculum assembled by the first curating teacher and add a twelfth instructional unit created by a fifth initial teacher that includes a text introducing the three laws of thermodynamics. The course curriculum assembled by the second curating teacher may be made available to other teachers and adopted in its entirety by a first adopting teacher without modification.

As an extension of the example above, it is easily appreciated that many teachers throughout the world can create text, videos, audio clips, images, graphs, charts, quizzes, tests, individual challenge problems, study guides, outlines, evaluation benchmarks, and/or any other instructional units. Any of these teachers or other teachers may combine instructional units to form chapters, units, or even whole digital textbooks. Others may then take these combinations or portions of these combinations to create additional chapters, units, or even complete digital textbooks.

With traditional physical and digital textbooks, income (e.g., royalties) is divided among authors, publishers, advertisers, distributors, and others per pre-negotiated arrangements. For example, a publisher of a textbook may pay a royalty to two authors of a textbook, and the two authors may decide (e.g., via a contract) to split the royalty evenly. The traditional model of royalty distribution is inadequate for an ecosystem in which numerous content creators and curators cooperate (perhaps unknowingly) to create a compilation of instructional units.

According to various embodiments of the systems and methods described herein, a teacher that curates or assembles instructional units may be allocated a curation fraction value (CFV). For example, 10% of royalties received for a given collection of instructional units may be allocated as a CFV to the teacher who curated or assembled the collection of instructional units. The remaining 90% of the royalties may be distributed among the initial teachers that created the individual instructional units. In some instances, some of the instructional units may themselves be compilations of instructional units (e.g., sub-instructional units or nested instructional units), in which case the share of the royalty allocated to such the assembled instructional unit may be further divided among the curator of the assembled instructional unit and the individual creators of the nested instructional units.

Traditional paper bookkeeping approaches do not allow for the automatic division of royalties among contributors (whether original content creators or curators of content) due to the high transactional cost and impossibility of connecting the various entities. In the digital world, digital instructional units may include annotations or metadata that allow a computing system to quickly calculate and distributed royalties through any number of recursive layers of curators and content creators.

Additional examples and details are described below with additional clarity in the context of specific terms used in this detailed description and in the claims. A large plurality, as used herein, is a number greater than 20. In many instances, manual or human-implemented processes may be sufficient for an activity that involves only a few elements. However, computer-implemented systems and methods may be utilized and adapted for situations involving a large plurality of actions or involved entities. Such implementations cannot be implemented manually or in the human mind due to the impossibility or impracticality (e.g., due to time, financial, data storage, or computational constraints).

As used herein, a reference from data object A to data object B exists where a system includes data or algorithms that, given object A, identify object B. For example, a reference may be a pointer in which object A contains the address of object B in memory, an index in which object B is stored in an array and object A stores the index of object B in the array, or a key stored in object A that provides access to object B. Other reference types known by those of skill in the art may be utilized in addition to or instead of the specific examples of references described herein.

As used herein, an identifier is a data object that is uniquely associated with another data object. Thus, knowledge of an identifier object allows the system to uniquely identify an associated other data object. In various embodiments, an identifier may be uniquely associated with a scope or range of the associated data objects (e.g., the identifier may be associated with a subset or portion of the associated data object). For example, a marker for a video annotation may be an identifier data object that is uniquely associated with a specific timestamp or time range within a specific video.

As used herein, an instructional unit may be any type of digital content that provides instruction or information. Examples of instructional units include, without limitation, passages of text, video clips, audio clips, drawings, graphs, charts, challenge problems, hyperlinks, HTML code, XML data, spreadsheets, databases, pseudocode, simulations, data objects, and images. In some instances, an instructional unit may comprise multiple, smaller instructional units. For example, an instructional unit may be multiple chapters of text. Each individual chapter may itself comprise an instructional unit. Sections within a given chapter may themselves comprise instructional units. An atomic instructional unit is an instructional unit that cannot be further divided into other instructional units.

As used herein, an instructional unit that comprises additional instructional units may be referred to as an electronic or digital book or an eBook. Thus, an eBook may include various types of instructional units in any of a wide variety of arrangements. An eBook may comprise other eBooks. One type of instructional unit is a student problem or challenge problem, which may be generally referred to as “problems.” A problem is generally intended for a student or other person learning from the eBook or another instructional unit to exercise their understanding of certain concepts. Examples of problems include, but are not limited to, multiple-choice problems, short text answer problems, drag and drop problems, digital ink drawing problems, and annotation-based problems.

Examples of different types of challenge problems and approaches for automatic and semi-automatic grading thereof are described in U.S. patent application Ser. No. 14/311,577 filed on Jun. 23, 2014, titled “Systems And Methods For Assessment Administration And Evaluation;” U.S. patent application Ser. No. 16/444,316 filed on Jun. 18, 2019, titled “Edited Character Strings;” and U.S. patent application Ser. No. 16/127,190 filed on Sep. 10, 2018, titled “Systems And Methods For A Selective Visual Display System To Facilitate Geometric Shape-Based Assessments,” each of which is hereby incorporated by reference in its entirety.

A problem representation is a data object that specifies the problem and a presentation algorithm is computer code (e.g., processor-executable instructions stored on a non-transitory computer-readable medium) that converts the specified problem for representation or presentation via visual, audible, and/or haptic presentation of the problem to the student or other learner (or, more generally, a “use” of an eBook). An answer interaction algorithm may be implemented using computer code that allows the student to interactively create and/or edit a data object that becomes their answer representation for the problem. After a student has answered a problem, the grade rules are applied to provide the student with feedback and/or compute a score for the problem.

A video annotation instructional unit is a type of problem representation instructional unit that presents a video clip or video clips to a student along with one or more markers. A challenge problem may instruct the student to use a marker to mark a location within a video clip as a response. The student may use a marker to mark a specific time or range of times. A text segment instructional unit may include any sequence of characters arranged in a string (e.g., a string data type or data object).

As understood in the art, a string may be a sequence or array of characters used to form words, sentences, descriptions, phrases, and/or otherwise convey information to a reader or viewer. Strings may have encodings that translate binary numbers or sequences of binary numbers into characters of a selected language. Examples of such encodings include, for example, 8-bit ASCII encodings or ISO-Latin encodings. Alternative examples, such as UNICODE, use more than 8 bits to capture the character set of most of the world's commercial languages and associated punctuation, symbols, spaces, line feeds, tabs, etc.

In some instances, text may have additional markup or annotation, such as bold, italics, or superscript. Many other forms of markup are possible and contemplated by this disclosure. The systems described herein may utilize a text markup system, such as HyperText Markup Language (HTML). In various embodiments, a text segment instructional unit may include embedded instructional units, such as images or other embedded media.

A text annotation instructional unit may include a text string presented to a student along with one or more “markers” Each marker may be a particular type of mark that can be placed in a text segment instructional unit to mark a portion of text. A student-placed mark may itself be a data object that has an implicit or explicit reference to a marker. A marker may be associated with a specific question related to the text segment instructional unit.

A grade rule includes at least a grade rule representation, a grading algorithm, and feedback. A grade rule representation is a data object that describes some set of possible student answers. A grading algorithm may include computer code that takes a student answer and a grade rule representation to determine the applicability of each of a set of grade rules apply (if any) to a student answer to the problem. In the context of video annotation challenge problems, a grade rule may include marker identifier, a start video time, an end video time, and/or a score or other feedback component. A grade rule may be associated with a particular video annotation instructional unit. A grade rule may be triggered when a student answer in the form of a marker in a video annotation instructional unit meets triggering criteria. Triggering criteria may be expressed in pseudocode as follows, for example:

Rule.startTime<=Mark.videoTime<=Rule.endTime

And

Rule.markerId==Mark.markerId

When a grade rule is triggered, the system may associate the score and/or feedback with the student answer. In some embodiments, a default grade rule may be established for a video annotation unit. The default grade rule may be triggered by any student mark in a video clip that does not trigger any other grade rule associated with a given video annotation unit. The default grade rule may have a marker identifier and feedback. Since the default grade rule applies to any student mark that does not trigger any other grade rule, the default grade rule may not include start and end times.

Feedback associated with one or more applicable grade rules may be applied to the student's answer and presented to the student. Feedback may be any type of data object that provides objective or subjective feedback with respect to the quality of the student answer and then presented visually, audibly, and/or haptically to the student. The feedback may itself be an instructional unit. For example, an eBook may have instructional units that teach about a subject, instructional units that are challenge problems soliciting answers from a learner, and instructional units that provide feedback with respect to the answers provided by the learner.

Video instructional units may be defined in terms of a start time and an end time. A user may place a marker or annotation at a video time defined with respect to the beginning time of the video or the end time of the video. For example, a student may place a marker at time 2:08 defined relative to the start of the video at 0:00. In some instances, a student (or another user) may use a keyboard, mouse, touch screen, or another peripheral interface device to specify the time at which a marker should be added and/or the spatial location within a video where the marker should be added. The term “click” may be used to refer to such an input, even though it is appreciated that such an input may be a mouse click, finger touch, keypress, audible instruction, or other user-input. The time associated with an input, such as a click, may be recorded and associated with a timestamp that records the time and/or date that the click was input and the play head time of a video being played or paused. In this context, the play head is used to describe the time in a video that is currently playing or paused measured with respect to the start of the video (or, alternatively, the end of the video). Thus, the play head may define a video time for the current frame of a video.

The term group is an instructional unit that includes an ordered list of instructional units, including ordered lists other groups. Groups may be used to provide a structure to an eBook. Paragraphs, sections, and chapters are examples of groups that may exist in both eBooks and physical books. eBooks are more flexible and dynamic than physical books, and so other types of groups or functional groups of instructional units are possible. For example, a group may be interactively “closed” so that it only displays a brief description or heading and when “opened” expands, opens a new tab, opens a new window, opens a video, begins playing an audio clip, etc.

The contents of an eBook may be represented as a group. Each group may contain other groups, and each group contains one or more instructional units, which my themselves contain other instructional units. Accordingly, the structure of an eBook may be modeled as a tree structure that defines the content of the book. An eBook has a root group from which all its content can be accessed.

An eBook may be created by interactively editing various instructional units within a group-based tree structure. In addition to editing instructional units into an eBook, it is also possible to copy instructional units in their entireties or piecemeal from other eBooks, catalogs, marketplaces, or other sources of instructional units. The initial creators of instructional units and the curators of compilations of instructional units (eBooks) should be compensated. Various embodiments of the presently described systems and methods track the owners (creators and curators) of instructional units and eBooks and recursively calculate royalty distributions, as described in detail herein. Tracking such ownership relationships in the human mind or through contractual obligations and other legal instruments is impossible because of the complexity and because there may not be any communication or relationship between the various owners. Thus, negotiated royalties are not possible. In the contemplated ecosystem, owners of all types rely on the computer-based systems and methods described herein.

The original creator of an instructional unit may be the initial owner (a creator owner) of the instructional unit. The creator owner may sell the ownership rights to another entity (a purchasing owner). Creator owners and purchasing owners are referred to herein as “unit owners.” An entity that owns the rights to a compilation or curation of multiple instructional units is referred to herein as an “assembly owner.” Unit owners and assembly owners may generally be collectively referred to as “owners.”

Royalties, such as book royalties, relate to a portion of income or profits to be paid to an entity (e.g., a person or company) in connection with the distribution or sale of an item, such as a book in the case of book royalties. A single author may receive 100% of the royalties associated with book sales. In contrast, a royalty distribution may be applicable to the sale of books with multiple authors. In the case of multiple authors, a royalty distribution may specify the fraction of a royalty that goes to each respective author. In some instances, the rights to the royalties may have been sold or possibly resold, such that a new entity may be entitled to an original author's share of a royalty.

The original author or subsequent entity assuming the rights of the original author may be referred to herein as an owner. Thus, an owner may be an original content creator, a content curator, or a subsequent entity entitled to the royalties derived from the original creation or curation. For traditional physical and digital textbooks, royalty distribution to owners is usually settled by contracts prior to sales. Various embodiments of the systems and methods described herein allow for royalty distributions in ecosystems in which many owners dynamically create and curate (e.g., collect, assembly, etc.) digital content.

In contrast to traditional approaches, the presently described systems and methods allow for the compensation of the original owners of digital content that is copied and used in curated collections. The presently described systems and methods also provide an automated royalty distribution calculation for a large plurality of owners, including through a recursive evaluation process when digital content has been curated and combined multiple times.

The presently described systems and methods relate to computer-implemented methods, processor-executable instructions stored on a non-transitory computer-readable medium, and systems with hardware, software, and/or firmware modules for calculating royalty distributions to content creators and curators. In this disclosure, various data representations and operations are presented in plain language or pseudocode based on no particular programming language or storage format.

The term “owner value profile” (OVP) is a data object that maps owner references to numeric values that represent the value to which each owner of an instructional unit. The value associated with a particular instructional unit may be based on, for example, the number of words in the instructional unit, market prestige of each owner, or time spent by each owner developing their respective instructional unit(s). In some examples, the value of an instructional unit may be based on the nature and/or measured use of the instructional unit.

For an OVP data object, the value for a particular owner may be referred to or retrieved via an ovp.owner operation. For example, an OVP may be a table that stores [owner, value] pairs. An access algorithm may search for a pair that specifies a particular owner and return an associated value. The OVP may list each owner only once and include a total value for all instructional units owned by a given owner. Alternatively, the OVP may list each owner any number of times, depending on the number of instructional units owned by a given owner.

For an OVP data object, an operation ovp.owner=value may be utilized to assign a value to a particular owner. An emptyOVP( ) operation may be used to specify the creation of a new OVP for which all owner values are zero. An operation for scalar multiplication may be specified as ovpNew=ovpA*S that defines the creation of a new OVP from an existing one by multiplying each owner's value by the scaler S. One possible embodiment of pseudocode for scalar multiplication is presented below:

ScalerMultiply(ovpA:OVP, s:number):OVP{

ovpNew = emptyOVP( );
for each owner in ovpA {

ovpNew.owner = ovpA.owner*s;

}
return ovpNew;

}

For a given OVP, an owner fraction profile (OFP) data object may map owner references to a fraction of ownership for each referenced owner. An OFP may be generated from an OVP based on the total value associated with each respective owner relative to the total value of all owners. One possible embodiment of pseudocode for generating an OFP from an OVP is provided below:

fractionate( ):OFP{

ofp = emptyOFP( );
sum = the sum of all values in this OVP
for each owner in this {

ofp.owner = this.owner * (1/sum);

}
return ofp;

}

The system may distribute a royalty for an eBook among owners. As described herein, the owner of an instructional unit may be an original or initial creator of an instructional unit and/or the assembler or curator of an instructional unit. Instructional units may themselves be eBooks that include nested instructional units. Thus, the system may recursively determine OFP data objects for each OVP of each eBook. An OVP of an eBook may identify an owner of an instructional unit entitled to an OFP of a royalty. The system may determine that such an owner is actually a curated of a nested eBook and allocate to that owner a CFV share and determine the OFP for the owners of the instructional units within the nested eBook. The system may implement a recursive identification of owners through multiple nested levels of curated and created instructional units.

The system may compute, calculate, or otherwise determine a value unit for each instructional unit of an eBook to facilitate the distribution of a royalty for an eBook. In one embodiment, the system may compute an OVP for the eBook. The system may then calculate an OFP for the OVP. The OFP provides a percentage of royalty that should be given to each owner identified in the OVP. The presently described systems and methods compute an OVP that may include owners of nested eBooks, for which nested OVPs may be computed. Unlike traditional approaches, the presently described systems and methods allow for recursive calculations of the portion of a royalty merited by each owner (creator and/or curator) of an eBook, including the further divided portion of the royalty merited by each owner of and each successively nested eBook.

In some embodiments, the system may calculate a value unit for each instructional unit based on an intrinsic property of each respective instructional unit. The system may calculate a value unit for each atomic instructional unit based on intrinsic characteristics of the atomic instructional unit itself and sum those to determine the value of a given instructional unit. A value unit of an atomic instructional unit may, for example, be based on the total number of fragments in the atomic instructional unit. For example, a text instructional unit may be broken into words or characters. In such examples, the number of words or characters may be calculated to determine the unit value of the atomic instructional unit. The unit value of an image instructional unit may be equal to the number of pixels in the image or the dimensions of the image relative to the size of the displayed eBook. The unit value of audio or video atomic instructional units may be calculated based on the number of seconds, frames, or samples. In other examples, the system may use other unit values associated with basic fragments of an atomic instructional unit to calculate the unit value thereof. For a given atomic instructional unit, a number of fragments nFragements may be used to determine the value unit of the atomic instructional unit. An example of pseudocode for such a calculation may be expressed as:

unit.value=nFragments*fragmentValue.

In some instances, an instruction unit may include different types of atomic instruction units. Atomic instructional units with lots of words or large pictures may be calculated as more valuable than an atomic instructional unit with relatively fewer words or relatively small pictures. This simplistic approach for value calculation may be suitable in some instances. In other instances, as described below, alternative or additional value calculation metrics may be utilized.

In some examples, problem instructional units may have grade rules associated with feedback, as described herein. A given type of grade rule can have a value, and the associated feedback can have a separate value. The value of each grade rule may be specified in pseudocode as follows:

gradeRule.value=RuleValue+gradeRule.feedback.value

Similarly, the value of a problem may be specified in pseudocode as follows:

problem.value=problem.nFragments*fragmentValue+sum(gradeRule.values)

In some embodiments, the system may compute the value of a group of instructional units by summing the OVPs of the instructional units that make up the group. In some embodiments, the system may further account for the effort to organize the group of instructional units. For instance, the system may assign a CFV to the curator or assembler of the group of instructional units. The CFV may, for example, be a function of the number of uniquely owned instructional units in the group. Groups of instructional units formed from a large number of uniquely owned instructional units may require more effort to assemble. In contrast, groups of instructional units that only include a few uniquely owned instructional units may require significantly less effort to assemble. The system may allocate a CFV commensurate with the effort expended. The value of a particular group of instructional units may be expressed in pseudocode as:

group.value=group.creatorValue+sum(child.value for all instructional units in the group)

As an example, a curator may copy an instructional unit U from a first eBook for inclusion in a second eBook. The curator may copy various other instructional units from various other sources as part of the creation of the second eBook. The value of the second eBook may exceed the sum of the values of the individual instructional units. The owner of the second eBook may also invest time and/or money in the promotion of the second eBook, for which additional compensation is merited.

In some embodiments, the system computes a new value unit for each instructional unit, including the instructional unit U, that accounts for the incremental increased value due to the curation and inclusion of the instructional unit in the second eBook and/or the investment in the promotion of the second eBook. A new instructional unit, U′, may contain a reference to the original instructional unit U. In other embodiments, a curationFraction is defined for the second eBook and a CurationOFP for the unit U′. Psuedo code may be used to represent such an approach as follows:

U′.value=U′.CurationOFP*curationFraction+U.value*(1−curationFraction)

Accordingly, the OVP of an eBook is the root.value for the root group of an eBook. In some embodiments, the system may calculate the OVP for an eBook based, at least in part, on the usage of each instructional unit by a user (e.g., a student or other learner). For example, an entity may copy the first eBook in its entirety to create a second eBook. The entity may add a relatively useless appendix that is objectively large compared to the first eBook. In such an example, the intrinsic value of the appendix may be measured to be greater than the first eBook. However, the actual value of the appendix may be relatively low.

In some embodiments, consumption of the eBook may be tracked to determine the usage of each instructional unit by each purchaser of the second eBook. The system may calculate royalty distributions based, at least in part, on the actual measured usage (e.g., a usage metric) of the eBook by the student, purchaser, or another user of the eBook. Any of a wide variety of purchasing software, digital libraries, and payment methods may be used to give a user (such as a student) access rights to an eBook. In some instances, the user may be the purchaser, while in other instances, a third party may pay for an eBook that is delivered to or otherwise made accessible to a user.

In some embodiments, the system may track usage of instructional units by students (or other users) by creating a StudentUnit object with [Unit, Student] combinations. Pseudocode for creating a new Student Unit may be expressed as:

new StudentUnit(Unit,Student)

The new StudentUnit operation may be used to store information about the activity of the student with respect to each instructional unit within a purchased (or otherwise used) eBook. Other operations for StudentUnit data objects expressed in pseudocode include:

s: StudentUnit=new StudentUnit(unit,student);

s.unit→the Unit provided in the construction operation

s.student→the Student provided in the construction operation

If the instructional unit is a group or an eBook with nested instructional units, an additional operation for StudentUnit data objects may retrieve information for all of the child instructional units. Such an operation may be expressed in pseudocode as:

s.children→a list of StudentUnits where for each Unit (child) in

s.unit.children there is a StudentUnit(child,s.student).

If the unit is not a group, then the additional operation to retrieve all of the feedback units attached to the instructional unit may be expressed in pseudocode as:

s.feedback→a list of StudentUnits where for each Unit (feedback) in

s.unit.feedback there is a StudentUnit(feedback,s.student).

For each instructional unit (u), the following operation expressed in pseudocode may also be used to identify a complete list of StudentUnit data objects created with respect to a given Student Unit. Such an operation may be expressed in pseudocode as:
u.studentUnits→a list of all StudentUnits that have been created using Unit u.

In many instances, an eBook with multiple instructional units may not be displayable on an electronic display screen in its entirety all at once. In some embodiments, a user may scroll through the text of an eBook, but this may be tedious with a large text. In other embodiments, a user may interactively open and close units, chapters, sections, etc. For example, when an eBook is first loaded, a root group or list of instructional units may be displayed, and the rest of the instructional units may be closed or accessible through hyperlinks. In some embodiments, closed instructional units may be identified by a displayed title or other summary information. In some embodiments, the system may display an estimated time to complete each instructional unit proximate each closed instructional unit. In some embodiments, the system may display an average time to complete, a time limit to complete, a difficulty level, and/or other information related to some of the closed instructional units.

The system may allow closed instructional units to be interactively opened by the user. If a given unit is never opened by a user or opened for an amount of time insufficient for the user to gain significant value, the system may decrease or set the unit value of the instructional unit accordingly (e.g., zero value or a nominal value).

In some embodiments, each StudentUnit data object may include a usage metric, such as persistent data that is initially assigned a value of “not opened.” The system may update the persistent data if the student opens the associated instructional unit. In some embodiments, the persistent data value may be incrementally increased (linearly or non-linearly) each time a student opens the instructional unit. In some embodiments, the system may use the recorded information about which units have been opened to define a new OVP called Opened OVP that apportions value based on which units have been opened by students. As an example, pseudocode for an Opened OVP via a definition of a result (rather than a specific implementation) may be expressed as follows:

StudentUnit.OpenedOVP( ){

If studentUnit.unit is a Group{

if (studentUnit.opened) then

let ovp = studentUnit.unit.creatorValue;
for each child in studentUnit.children {

ovp = ovp + child.OpenedOVP( );

}
return ovp;

} else {

return 0

}

} else {

If (studentUnit.opened) then {

Let ovp = studentUnit.unit.OVP;
For each feedback in studentUnit.feedback {

ovp = ovp + feedback.OpenedOVP( );

}
return ovp

} else {

return 0}

}

}

In some embodiments, once an instructional unit is opened, the value of the instructional unit may be assigned based on an intrinsic value, as described above. Using the Opened OVP as a royalty allocation, the system may distribute a royalty to the owners of only those instructional units that were actually opened and used. In such examples, the value book. root.OpenedOVP( )may return an OVP for an entire eBook. An example of pseudocode to effectuate such an allocation is presented below:

Unit.OpenedOVP( ){

Let ovp = emptyOVP( );
For each studentUnit in unit.studentUnits {

ovp = ovp + studentUnit.OpenedOVP( );

}
return ovp;

}

The embodiments described above may be suitable in some instances. However, in other instances, an alterative embodiment may be utilized that allocates value to instructional units based on time-based usage. For example, if a student opens all of the instructional units within an eBook just to see what is in them, the value unit assigned to each instructional unit via the Opened OVP model described above may not accurately represent the actual value derived by the student. Accordingly, in some embodiments, the system may track the amount of time spent using, viewing, editing, manipulating, or otherwise interacting with each instructional unit. For example, the system may detect when a portion of or an entire instructional unit has been scrolled out of sight or a window has been minimized.

The system may associate a usage metric, such as “time-in-use” value, with each StudentUnit data object. The system may define a Time OVP as an operation that apportions value to instructional units based on a measure, estimated, or reported amount of time a student or other user has accessed each respective instructional unit. An example of pseudocode for a Time OVP via a definition of a result (rather than a specific implementation) is provided below:

StudentUnit.TimeOVP( ) {

If studentUnit.unit is a Group {

let ovp = studentUnit.unit.creatorValue;
for each child in studentUnit.children {

ovp = ovp + child.TimeOVP( );

}
return ovp

} else {

let ovp = studentUnit.timeInUse*studentUnit.unit.OFP;
for each feedback in studentUnit.feedback {

ovp = ovp + feedback.TimeOVP( );

}
return ovp;

}

}

The Time OVP for an instructional unit combines the Time OVP calculated from all StudentUnits associated with each respective instructional unit. The value book.root.TimeOVP( ) may return an OVP for an entire Ebook. Pseudocode for an example Time OVP for each instructional unit may be expressed as follows:

Unit.TimeOVP( ){

Let ovp = emptyOVP( );
For each studentUnit in unit.studentUnits {

ovp = ovp + studentUnit.TimeOVP( );

}
return;

}

In some embodiments, the system may further use an interactive time usage metric to assign value units to each respective instructional unit of an eBook. For example, the value derived by a student actually watching a video is greater than the value derived by a student who starts a video but then walks away and lets it play to its conclusion. Accordingly, the system may track interactive behaviors with each instructional unit within an eBook. Examples of interactive behaviors that could be tracked and/or detected include, but are not limited to, opening a unit, scrolling, selecting something, clicking, presence tracking, eye movement, and the like. Accordingly, the system may specify a maximum-inactive-time threshold value. Value assigned to a given instructional unit may be based, at least in part, on the total amount of time spent by a student (or another user) on a given instructional unit. However, the total interaction time associated with a given instructional unit does not incrementally increase after a maximum-inactivity-time threshold has been reached during which no interactive behavior has been detected by the student.

In one embodiment, an eBook is displayed at a first brightness level via an electronic display. A usage time metric associated with each instructional unit is increased as the student uses each respective instructional unit. The system may automatically dim the brightness level after a maximum-inactive-time threshold amount of time has passed without the system detecting an interactive behavior from the student. The usage time metric associated with the instructional unit being displayed ceases to increment until the student generates a detectable interactive behavior. The detected interactive behavior may cause the usage time metric to begin incrementing again and cause the display to revert to the first brightness level.

In other embodiments, a video or audio clip being played back may include pauses or other prompts requesting that a student confirm that they are still present and using the instructional unit. Example pseudocode to implement a time-since-last-interaction tracking for StudentUnit data objects is expressed below:

studentUnit.timeSinceLastInteraction = currentTime −

studentUnit.timeOfLastInteraction

if (studentUnit.timeSinceLastInteraction >

studentUnit.unit.maxInactiveTime) {

studentUnit.timeInUse = studentUnit.timeInUse +

unit.maxInactiveTime

} else {

studentUnit.timeInUse = studentUnit.timeInUse +

studentUnit.timeSinceLastInteraction

}

In other embodiments, the system may implement a time-usage tracking approach that is less flexible, but perhaps simpler, that limits or caps the amount of usage time allocated to a given instructional unit each time it is opened (e.g., via a maximum-time threshold value).

Per any combination of the various examples and embodiments described herein, a recursive royalty system may manage royalty distributions for electronic books (eBooks) that are dynamically assembled from instructional units with nested ownership. The system may include or utilize an external rendering subsystem to render an eBook for display on a digital electronic display for viewing by a user. The displayed eBook may have been assembled from a plurality of instructional units that are owned by any number of different owners. Each instructional unit may be owned by a different owner, or each owner may own multiple instructional units. An ownership share subsystem may calculate a CFV for an assembly owner of the assembled eBook and generate an owner value profile (OVP) data object that associates a calculated value of each instructional unit with the owner thereof. In some embodiments, the ownership share subsystem may be divided (conceptually, physically, or logically) into a CFV subsystem and an OVP subsystem to calculate the relative ownership shares of the unit owners and the assembly owner.

One or more of the instructional units may comprise an embedded eBook that comprises a compilation or assembly of nested instructional units. In such instances, the system may recursively assign the identified unit owner of the embedded eBook as a nested assembly owner of the embedded eBook to generate a nested OVP data object for the embedded eBook. The system may associate a nested CFV of the embedded eBook with the nested assembly owner and calculate a nested OFP value for each owner of the nested instructional units. The royalty distribution subsystem may then compute a nested distribution of the distribution portion for the identified unit owner of the embedded eBook based on the nested CFV and the nested OFPs of the owners of the nested instructional units.

In various embodiments, the OVP subsystem may compute the value unit of each instructional unit based on one or more of: a number of characters, a number of words, a number of graphical displays, a length, a duration, and/or a number of pixels in the instructional unit. In some embodiments, the system may compute the value of each instructional unit based on a usage metric, such as a summed accumulation of time during which each respective instructional unit is (i) visible to the user and (ii) during which an interaction by the user is detected.

Any of a wide variety of digital content may be included within an eBook. Digital video and online text instruction formats are increasingly utilized as a part of student instruction. One challenge with digital video instruction is that it can be difficult to know or confirm that a student is paying attention to the video and/or learning from the video. Another challenge with digital video instruction is the lack of complex student problems that can be automatically graded and, optionally, present the student with useful, customized, and/or personalized feedback.

According to various embodiments, a challenge problem may be presented prior to or during a video presentation. The challenge problem may instruct the student (or another user) to identify and mark the answer to the challenge problem within the video. Student answers to such a challenge problem can be automatically graded using grading rules that specific video time ranges mapped to specific student feedback.

Similar to video instruction, it may be difficult to determine or confirm that a student is paying attention or learning from the online text displayed on an electronic display. In various embodiments of the presently described system and methods, an instructional unit may comprise complex student problems that can be automatically graded and/or provide useful feedback to facilitate student learning. For example, an instructional unit may comprise a segment of text associated with questions. A student may read the segment of text while looking for information that answers the questions posed. The student “solves” or responds to the problem by highlighting, underlining, marking, or otherwise annotating a portion of the text identified as being responsive to a posed question. A teacher or other grader may identify text selection ranges as “answer items” (that may also be instructional units). Each text selection range may be associated with feedback, such as numerical grades, letter grades, or other feedback.

Any combination of the various embodiments, examples, systems, and methods are possible. For example, a student instruction system may include an instructional unit subsystem to generate a graphical user interface (GUI) to facilitate the display of instructional units, challenge problems, markers, controls, and the like. The GUI may also facilitate the detection of user input with respect to any of a wide variety of instructional units, challenge problems, and/or markers. The markers may be applied by the students or other users to form answers to the challenge problem(s). The markers may be positioned to identify temporal locations along a timeline of a video in the case of video annotation instructional units or positioned to spatially identify words, lines, or paragraphs of a text annotation instructional unit.

A student answer subsystem may receive student answer markers, and a grade rule specification subsystem may display the collective student answer markers all at once relative to the instructional unit. The teacher (or another grader) may define grade rules relative to the instructional unit for application to various subsets of the student answer markers. As each grade rule is created, the student answers that are graded may be removed from the display to simplify and increase the efficiency of subsequent grade rule creation.

In various embodiments, the system and methods described herein may be provided as a computer program product including a computer-readable medium having stored thereon instructions that may be used to program a computer system or other electronic device to perform the processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/computer-readable media suitable for storing electronic instructions.

Computer systems and the computers in a computer system may be connected via a network. A computer system or computing device may include a workstation, laptop computer, disconnectable mobile computer, server, mainframe, cluster, so-called “network computer” or “thin client,” tablet, smartphone, personal digital assistant or another hand-held computing device, “smart” consumer electronics device or appliance, medical device, or a combination thereof.

Each computer system may include one or more processor and/or memory; computer systems may also include various input devices and/or output devices. The processor may include a general-purpose device, such as an Intel®, AMD®, or another “off-the-shelf” microprocessor. The processor may include a special purpose processing device, such as an ASIC, SoC, SiP, FPGA, PAL, PLA, FPLA, PLD, or another customized or programmable device. The memory may include static RAM, dynamic RAM, flash memory, one or more flip-flops, ROM, CD-ROM, disk, tape, magnetic, optical, or another computer storage medium. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

Suitable software to assist in implementing the systems and methods described herein is readily available for use by those of skill in the pertinent art(s) and includes, without limitation, programming languages and tools, such as Java, Pascal, C++, C, database languages, APIs, SDKs, assembly, firmware, microcode, and/or other languages and tools.

Several aspects of the embodiments described will be illustrated as software modules or components. As used herein, a software module or component may include any type of computer instruction or computer-executable code located within a memory device. A software module may, for instance, include one or more physical or logical blocks of computer instructions, which may be organized as a routine, program, object, component, data structure, class, etc., that perform one or more tasks or implement particular data types. It is appreciated that a software module may be implemented in hardware and/or firmware instead of or in addition to software. One or more of the functional modules described herein may be separated into sub-modules and/or combined into a single or smaller number of modules.

In certain embodiments, a particular software module may include disparate instructions stored in different locations of a memory device, different memory devices, or different computers, which together implement the described functionality of the module. Indeed, a module may include a single instruction or many instructions and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

The embodiments of the disclosure are described below with reference to the drawings, wherein like parts are designated by like numerals throughout. The components of the disclosed embodiments, as generally described and illustrated in the figures herein, could be arranged and designed in a wide variety of different configurations. Furthermore, the features, structures, and operations associated with one embodiment may be applied to or combined with the features, structures, or operations described in conjunction with another embodiment. In other instances, well-known structures, materials, or operations are not shown or described in detail to avoid obscuring aspects of this disclosure.

Thus, the following detailed description of the embodiments of the systems and methods of the disclosure is not intended to limit the scope of the disclosure, as claimed, but is merely representative of possible embodiments. In addition, the steps of a method do not necessarily need to be executed in any specific order, or even sequentially, nor do the steps or sequences of steps need to be executed only once or even in the same order in subsequent repetitions. As used herein, the term “set” includes a non-zero quantity of items, including a single item.

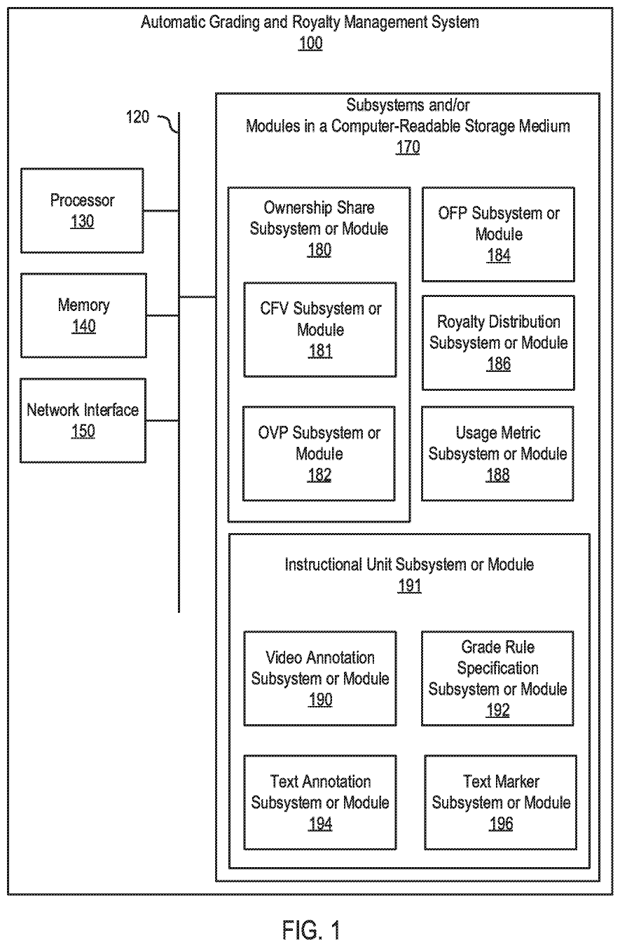

FIG. 1 illustrates an example of a computing system 100 to manage royalty distributions, according to various embodiments. The example computing system 100 includes a bus 120 connecting a processor 130, a memory 140, a network interface 150, and various subsystems and/or modules within a computer-readable storage medium 170. The subsystems and/or modules within the computer-readable storage medium 170 may include an ownership share subsystem or module 180 calculate a curation fraction value (CFV) for an assembly owner of the assembled eBook and generate an owner value profile (OVP) data object that associates a calculated value of each instructional unit with the owner thereof.

In some embodiments, the ownership share subsystem or module 180 may be conceptually, physically, or logically divided into a CFV subsystem or module 181 and an OVP subsystem or module 182. In such embodiments, the CFV subsystem or module 181 may calculate a CFV for an assembly owner of the assembled eBook. The OVP subsystem or module 182 may identify a unit owner associated with each instructional unit. Each identified unit owner may own one or more of the instructional units of the assembled eBook. The OVP subsystem or module 182 may compute a value unit of each of the identified instructional units. According to various embodiments, the value unit computed for each instructional unit may be based on an intrinsic characteristic of each respective instructional unit (e.g., number of words, number of characters, number of pixels, length, duration, etc.).

In other embodiments, the value unit computed for each instructional unit may be based on one or more usage metrics. In some embodiments, the OVP subsystem or module 182 may compute a value unit for each instructional unit based on a weighted function of intrinsic characteristics and one or more usage metrics. The OVP subsystem or module 182 may generate an OVP data object for the assembled eBook that associates each identified unit owner with a value sum of the computed value units of all the instructional units owned by each respective unit owner.

The subsystems and/or modules within the computer-readable storage medium 170 may, in some embodiments, further include an owner fraction profile (OFP) subsystem or module 184 to calculate an OFP value for each identified unit owner. The OFP subsystem or module 184 may calculate an OFP value of each unit owner based on the value sum associated with each respective identified unit owner divided by the total of all the computed value units. The OFP value may, for example, be expressed as a percentage of the royalty due to each respective unit owner.

The subsystems and/or modules within the computer-readable storage medium 170 may further include a royalty distribution subsystem 186 to compute a distribution portion for a royalty received for the assembled eBook based on the CFV of the assembly owner and the OFP values of the identified unit owners of the instructional units.

As described herein, the computing system 100 may compute the unit value of each instructional unit based on intrinsic characteristics and/or usage metrics. The subsystems and/or modules within the computer-readable storage medium 170 may further include a usage metric subsystem or module 188. The usage metric subsystem or module 188 may compute the value unit for each instructional unit based on intrinsic characteristics, a usage metric, a combination or weighted function of usage metrics, or a weighted function of intrinsic characteristics and one or more usage metrics.

An eBook may be purchased for a price P for use by a user (e.g., a student), and a royalty R may be marked for distribution to owners of the eBook and instructional units, including nested owners and of nested instructional units. The royalty R may be all the price P in some embodiments. In other embodiments, the royalty R may be the price P may be the price after deducting all or a portion of the marketing and/or marketplace support costs.

The system (e.g., which may be part of the marketplace or library from which the eBook was purchased) may then compute or retrieves the OVP for the root unit of the eBook, according to any of the embodiments described herein. The unit values of the OVP may be unitless or normalized for different instructional units. The system may convert the OVP (or otherwise calculate) an OFP for the eBook that identifies a fractional share to each unit owner. The OFP can then be multiplied by R (OVP*R) to compute the actual distribution of royalties to the various owners. The royalties can then be transferred to the accounts of the various owners listed in the royalty distribution OVP.

In some instances, an eBook may be assembled or curated from fragments or portions of other eBooks, which might themselves be created from other eBooks, and so on for any number of nested layers of eBooks. The owner list for an OVP and each nested OVP may be very large. The number of owners in an OVP may grow quite large, and the fraction of ownership for any given owner may grow vanishingly small. In some embodiments, the system may remove from the royalty distribution calculations any owners whose share of the royalty is less than a minimum threshold value or minimum threshold percentage. In some embodiments, the system may remove as many of the smallest fraction owners as possible without the sum of their fractions exceeding a threshold.

After removing owners whose share falls below the threshold, a new OVP and/or OFP may be calculated so that the full royalty can be apportioned to the remaining owners. For royalty distributions based on unit values computed using intrinsic characteristics of the instructional units, the royalty shares may be calculated and distributed at the time of sale or soon thereafter.

In contrast, for royalty distributions based on unit values computed using usage metrics, the royalty cannot be calculated or distributed until after a usage time period has passed. In some embodiments, the system may use a royalty distribution schedule that includes a list of [time,royalty] pairs or [time,fraction] pairs. A [time,fraction] pair can be converted into a [time, royalty] pair by multiplying the fraction times the royalty R. The times may be absolute times, or the times may be defined relative to the time of sale. At the appointed time or after the specified time period has passed, the system may calculate the OFP and distribute the royalty using based on value units for the instructional units based on usage metrics.

The subsystems and/or modules within the computer-readable storage medium 170 may further include an instructional unit subsystem or module 191 that includes a video annotation subsystem or module 190, a grade rule specification subsystem or module 192, a text annotation subsystem or module 194, and a text marker subsystem or module 196. The video annotation subsystem or module 190 may present a video clip (or video clips) plus one or more markers to a student. The marker identifies a “mark” that a student can place in or on a video (e.g., on a timeline playback tracker associated with a video) to identify a specific point in time, range of times, and/or a spatial location within a video frame as corresponding to an answer to a challenge problem. The timeline playback tracker or bar may include a playhead that indicates the current playback position relative to the beginning and end of the video.

The grade rule subsystem or module 192 may include an interactive computer interface that allows a user (e.g., a teacher) to specify a start time, a view time, an end time, a marker identifier, and associated feedback with a grade rule for video markers. Similarly, the grade rule subsystem or module 192 may facilitate the creation of grade rules for student answers to text annotation instructional units, as described herein. In some embodiments, the marker identifier may be specified implicitly or explicitly, and the feedback may include a score and/or commentary. In one example, the grade rule subsystem or module 192 may include a video player with playback controls for video annotations instructional units, or scrollable text and markers to specify the start and stop points and rule relationships for text annotation instructional units.

The system may detect an interactive event at any point during playback of a video clip (including when the video is paused) and save the time of the playback head as a “start time.” The system may detect a second event (possibly the same type of event or a different type of event) as an “end time.” The two events may, in some embodiments, be distinguished based on the type of event, based on the spatial location on the video at which each event is detected, and/or because the events are detected as originating from different input devices or even different computing devices. A user, such as a teacher, can edit the feedback that may include numerical scores, HTML, images, drawings, charts, video feedback, audio feedback, icons, graphics, or other presentation media.

The system may present all student answers to a particular video annotation informational unit to a teacher for grading. The teacher may specify a grade rule, as described above, that can be applied automatically to all the student answer items encompassed by the grade rule. The teacher may specify multiple grade rules that are applicable to the same video annotation information unit. In some embodiments, the system may display the timestamp or time range associated with each grade rule applicable to a given video annotation informational unit.

In various embodiments, the system may also display the mark points for each student answer item. The grader (e.g., the teacher or other user) may elect to have all student answer marks that match existing grade rules be removed from the display to enable the grader to readily see the remaining student answers for which an applicable grade rule has not yet been created.

The text annotation subsystem or module 194 may facilitate the creation and/or display of text annotation instructional units to students along with associated markers and challenge problems. Students or other users may utilize the GUI to place markers and/or otherwise annotate the displayed text to indicate the locations of answers in the displayed text to the challenge problems presented.

The text marker subsystem or module 196 may facilitate the placement of markers by students and/or the placement of grade rule markers by teachers. The text marker subsystem or module 196 may, in conjunction with the grade rule specification subsystem or module 192, facilitate the creation of grade rules for text annotation instructional units defined in terms of start and stop points. Grade rules for text annotation instructional units may further include relationship information defining the manner in which each grade rule should be applied to student answers to text annotation instructional units, as described herein.

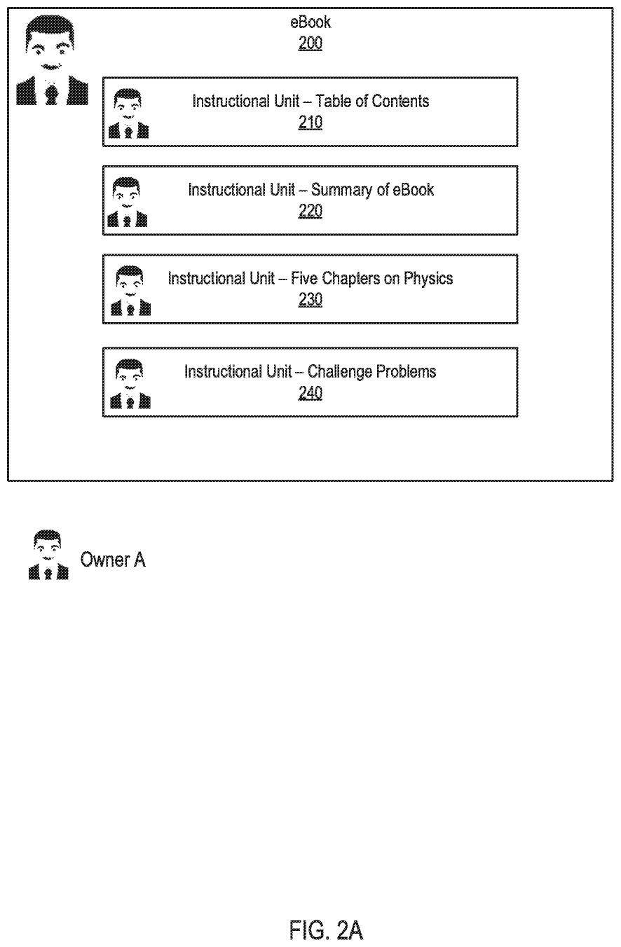

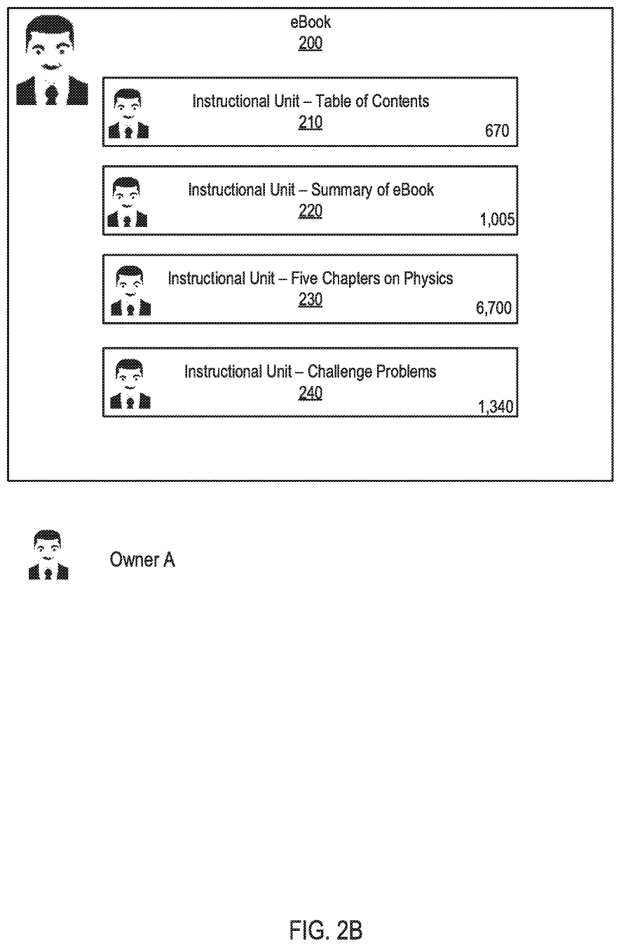

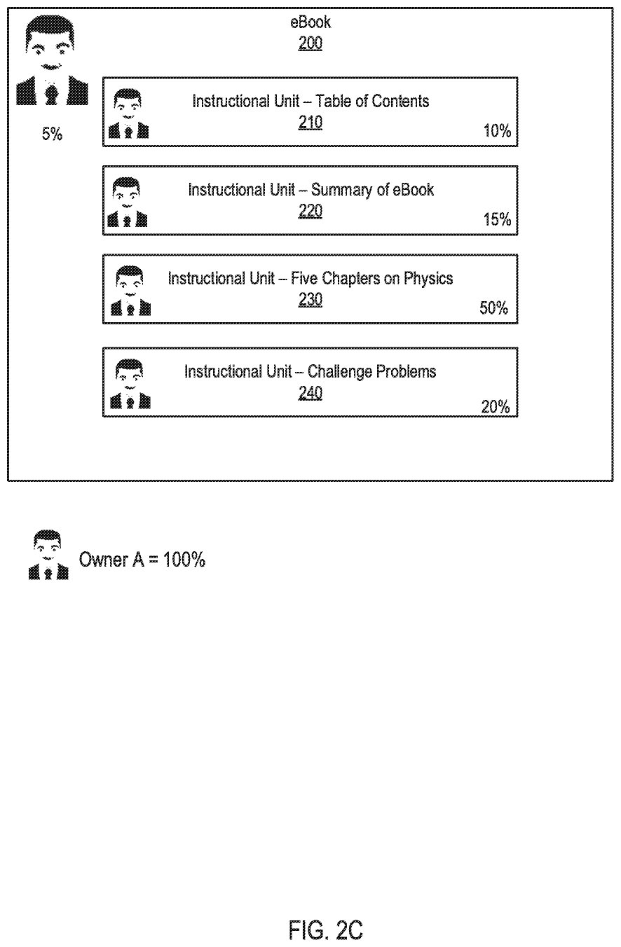

FIG. 2A illustrates an example of an eBook 200 with multiple instructional units 210, 220, 230, and 240, according to one embodiment. In the illustrated embodiment, each of the instructional units 210, 220, 230, and 240 is created by Owner A and combined to form the eBook 200 by Owner A. Accordingly, Owner A is the assembly owner for eBook 200 and the unit owner of each of the instructional units 210, 220, 230, and 240. Since eBook 200 is associated with a single owner, any royalty received would be allocated entirely to Owner A.

FIG. 2B illustrates the example eBook of FIG. 2A with unit values associated with each of the instructional units based on the total number of words in each of the instructional units. In the illustrated embodiment, the first instructional unit 210 is a table of contents with 670 words. The second instructional unit 220 is a summary of the eBook and includes 1,005 words. The third instructional unit 230 includes five chapters on physics with 6,700 words. The fourth instructional unit 240 includes challenge problems with 1340 words.

FIG. 2C illustrates the example eBook of FIGS. 2A and 2B with fractional share allocations based on a curation fraction value (CFV) for the curator of the eBook and owner fraction profiles (OFPs) for the owner of each instructional unit. In the illustrated example, Owner A is identified as the assembly owner of the eBook 200 and allocated a 5% CFV share of the royalty. The 5% is merely an example, and alternative fixed amounts or calculated curation values may be used in other embodiments.

A first instructional unit 210 is associated with a 10% share of the royalty based on the word count intrinsic characteristic of the instructional unit 210. The second instructional unit 220 is associated with a 15% share of the royalty. The third instructional unit 230 is associated with a 50% share of the royalty. The fourth instructional unit 240 is associated with a 20% share of the royalty. Again, because a single owner, Owner A, is the assembly owner and the unit owner of all the instructional units 210-240, the calculated royalty shares are unnecessary but illustrate a basic scenario.

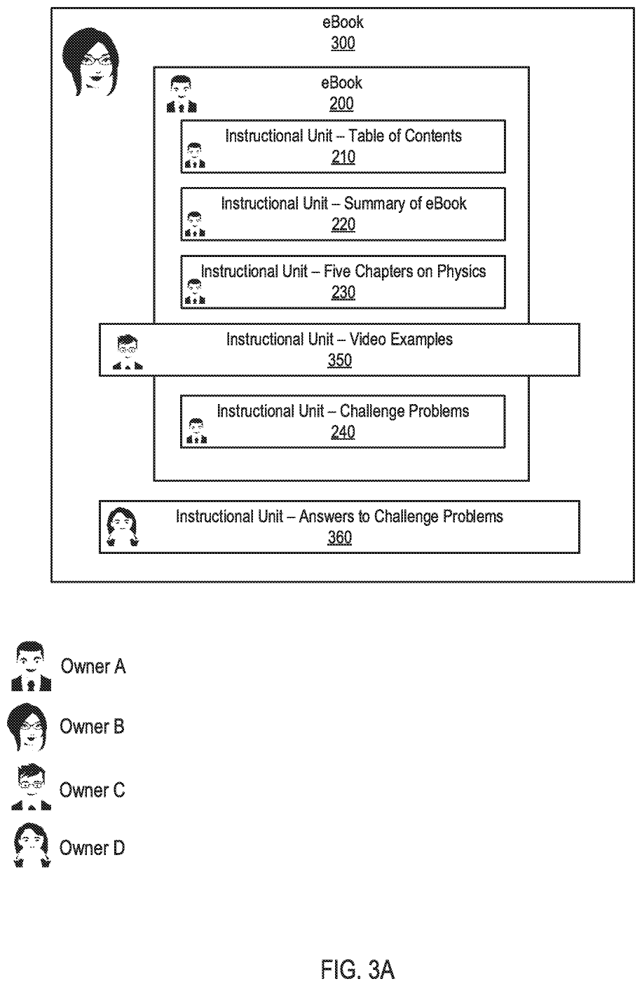

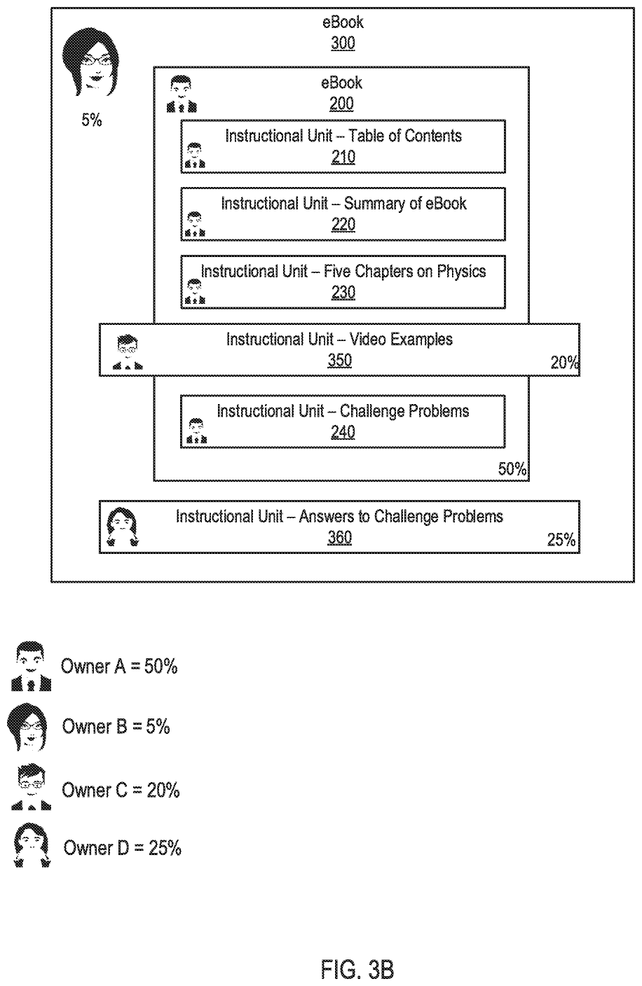

FIG. 3A illustrates an example of an eBook 300 curated by an assembly owner, Owner B, that includes a nested eBook 200 (from FIGS. 2A-2C) with additional instructional units 350 and 360 added that are each owned by different owners, Owner C and Owner D. Owner B assembled eBook 300 by inserting an instructional unit 350 of video examples between instructional units of the eBook 200. Additionally, an instructional unit 360 with answers to the challenge problems in instructional unit 240 of the eBook 200 has been added as part of eBook 300.

FIG. 3B illustrates fractional share allocations for the eBook in FIG. 3A based on CFV values for the assembly owner of the eBook and a first level of OFPs for the unit owners of each of instructional units, according to one embodiment. In the illustrated example, the assembly owner of the eBook 300 is assigned a 5% CFV for royalties associated with the sale of eBook 300. The system may compute values of each of the instructional units 210, 220, 230, 350, 240, and 360 using intrinsic characteristics of each respective instructional unit 210, 220, 230, 350, 240, and 360.

The system may then calculate an OFP value for each identified owner based on the sum of the value units of the instructional units owned by each respective owner. As illustrated, Owner A is allocated a 50% share for the sum of the value units of the instructional units 210, 220, 230, and 240. Owner C is allocated a 20% share based on the intrinsic characteristics of the video examples in the instructional unit 350. Owner D is allocated a 25% share based on the intrinsic characteristics of the answers to the challenge problems in the instructional unit 360.

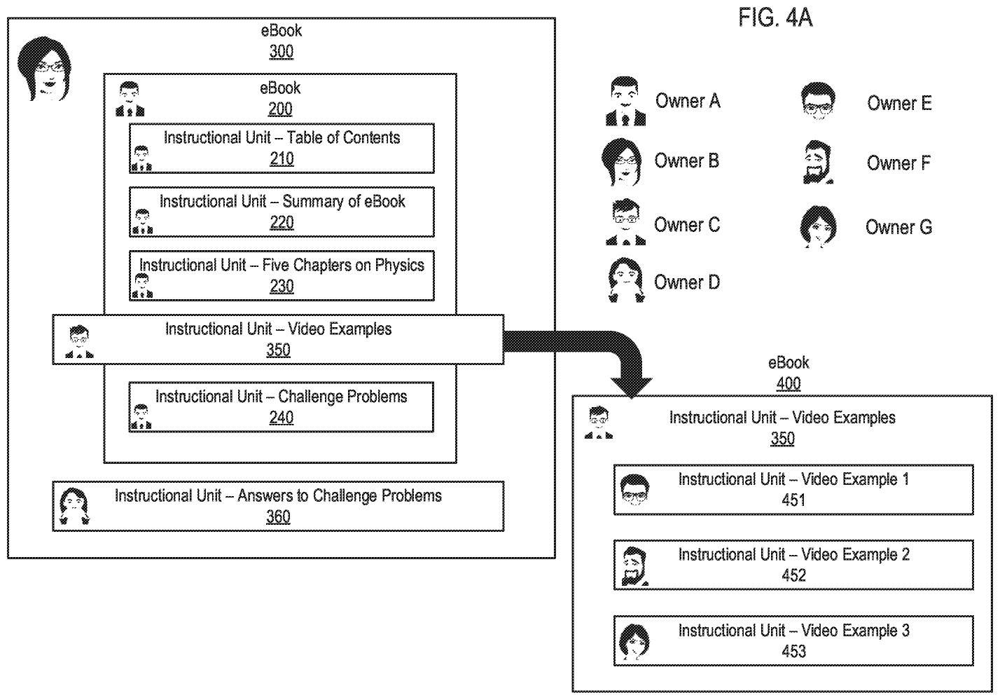

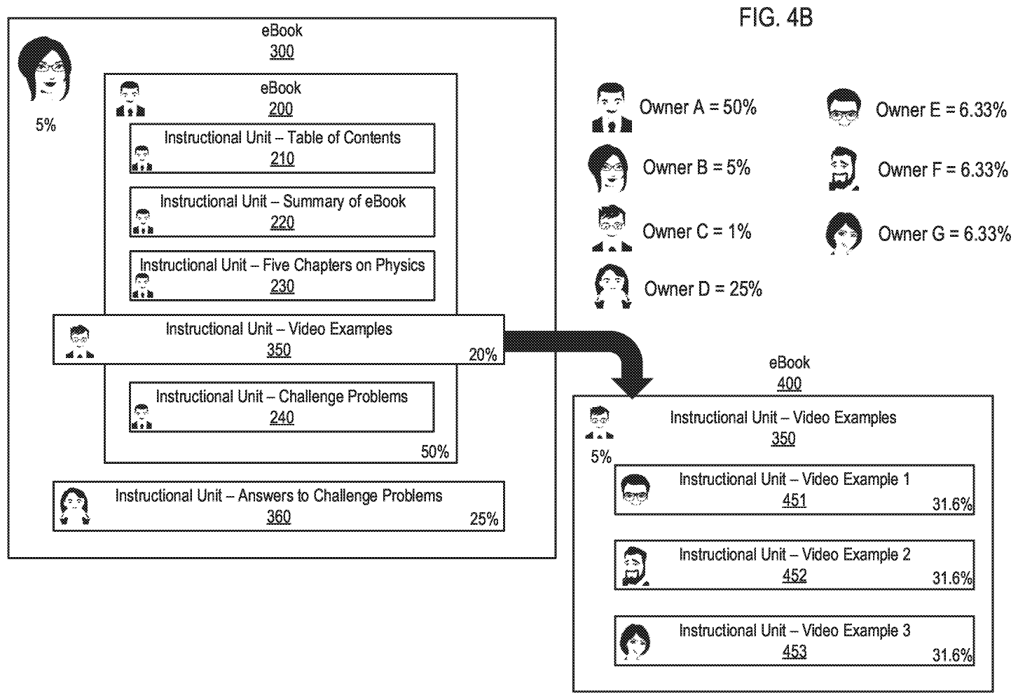

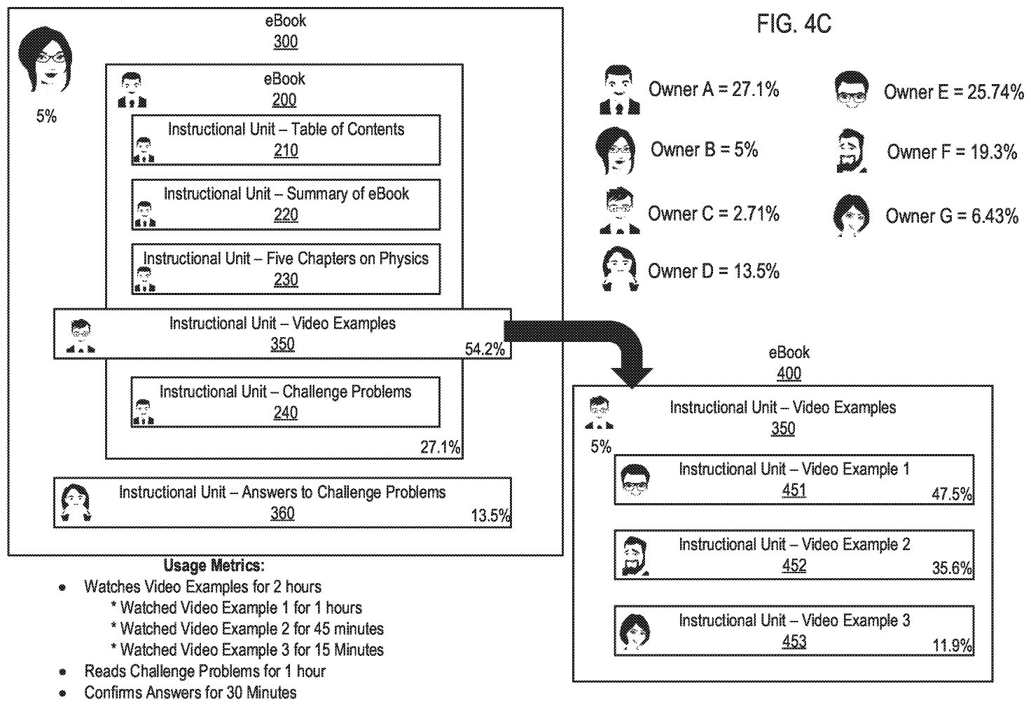

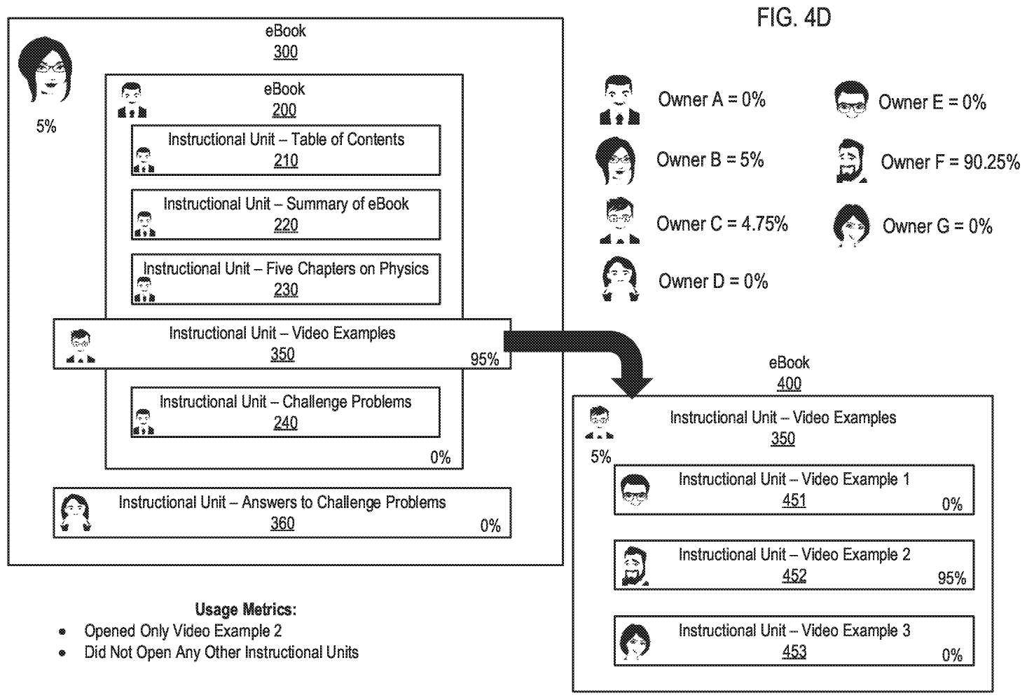

FIG. 4A illustrates an example of the eBook 300 from FIGS. 3A and 3B with the instructional unit 350 as a nested eBook 400 with three videos in nested instructional units 451, 452, and 453, each of which is owned by a different unit owner (Owner E, Owner F, and Owner G). At the first level of analysis, Owner C is identified as the unit owner of the instructional unit 350 with video examples that is a part of eBook 300. At a second level of analysis, the system identifies instructional unit 350 as being a nested eBook 400 with Owner C as the assembly owner thereof.

Owner E is the unit owner of the nested instructional unit 451 with video example 1. Owner F is the unit owner of the nested instructional unit 452 with video example 2. Owner G is the unit owners of the nested instructional unit 453 with video example 3.

FIG. 4B illustrates fractional share allocations for the eBook 300, including a breakdown of the fractional share allocations for the multi-owner nested eBook 400 that forms the instructional unit 350 of video examples in eBook 300. The system may compute the unit value of the instructional unit 350 with the video examples based on the intrinsic characteristics thereof. Ultimately, an OFP for the owner of the instructional unit 350 of the video examples is calculated as being 20%.

Through a recursive analysis of the nested eBook of nested instructional units 451, 452, and 453, the system determines that Owner C is allocated a 5% CFV share of the nested eBook 400, which equates to a 1% total share of the royalty for sales of eBook 300 (5% of 20%). Each of Owners E, F, and G receive equal OFP value shares of 31.6% of nested eBook 400 based on the intrinsic characteristics of nested instructional units 451, 452, and 453. Accordingly, each of Owners E, F, and G is allocated a 6.33% total share of the royalty for sales of eBook 300 (31.6% of 20%).

FIG. 4C illustrates fractional share allocations for the eBook in FIG. 4A based on time-based usage metrics, according to one embodiment. As illustrated, tracked usage metrics may indicate that a user watched the video examples in the instructional unit 350 for two hours, with one hour spent watching video example 1 in the nested instructional unit 451, forty-five minutes spent watching video example 2 in the nested instructional unit 452, and fifteen minutes spent watching video example 3 in the nested instructional unit 453. The tracked usage metrics may also indicate that the user read the challenge problems in the instructional unit 240 for one hour and the answers to the challenge problems in the instructional unit 360 for thirty minutes.

A CFV of 5% of any royalty received may be associated with Owner B for assembling eBook 300. The remaining 95% of the royalty is divided based on the usage metrics. The system may identify the owner of each instructional unit in eBook 300 and compute a value unit for each one based on the usage metrics. An OFP may be calculated for each owner of each of the instructional units in the eBook 300. An OFP of 54.2% is calculated for Owner C of the instructional unit 350 based on two hours of usage. An OFP of 27.1% is calculated for Owner A based on one hour of usage of the instructional unit 240. An OFP of 13.5% is calculated for Owner D based on thirty minutes of usage of the instructional unit 360.

However, the 54.2% share allocated to Owner C is based on the ownership of the instructional unit 350, which comprises the nested eBook 400 with nested instructional units 451, 452, and 452. Recursive analysis of nested eBooks results in Owner C being identified as the assembly owner of the instructional unit 350 and is therefore allocated a nested CFV of 5%. Owner C is ultimately allocated a 2.71% share based on an entitlement to 5% nested CFV of the 54% share associated with the instructional unit 350 of eBook 300.

Owner E is allocated a 50% share of the remaining 95% of the royalties for nested eBook 400, or 47.5%, because one of the two hours of video watching was spent on video example 1 of nested instructional unit 451. Accordingly, Owner E is ultimately allocated a 25.74% share of the royalties for the sale of eBook 300.

Owner F is allocated a 37.5% share of the remaining 95% of the royalties for nested eBook 400, or 35.6%, because forty-five minutes of the two hours of video watching was spent on video example 2 of nested instructional unit 452. Accordingly, Owner F is ultimately allocated a 19.3% share of the royalties for the sale of eBook 300.

Owner G is allocated a 12.5% share of the remaining 95% of the royalties for nested eBook 400, or 11.9%, because fifteen minutes of the two hours of video watching was spent on video example 3 of nested instructional unit 453. Accordingly, Owner G is ultimately allocated a 19.3% share of the royalties for the sale of eBook 300.

FIG. 4D illustrates fractional share allocations for the eBook 300 in FIG. 4A based on an open-tracking usage metric, according to one embodiment. As illustrated, tracked usage metrics may indicate that a user only opened video example 2 of the nested instructional unit 452 of the nested eBook 400 that forms the instructional unit 350 of eBook 300.

A CFV of 5% of the royalty may be allocated to Owner B for assembling eBook 300. The remaining 95% of the royalty of eBook 300 is divided based on the usage metrics. The entire 95% of the remaining royalty is allocated to the instructional unit 350 since none of the other instructional units 210, 220, 230, 240, or 360 were opened by the user. Nested eBook 400 forms instructional unit 350 and a recursive analysis of the nested eBook results in Owner C being allocated a CFV of 5% of the royalties associated with nested eBook 400, which equates to 4.75% of the royalty for eBook 300. Owner F is allocated 95% of the royalties for nested eBook 400, which equates to 90.35% of the total royalty for the sale of eBook 300 (95% of 95%).

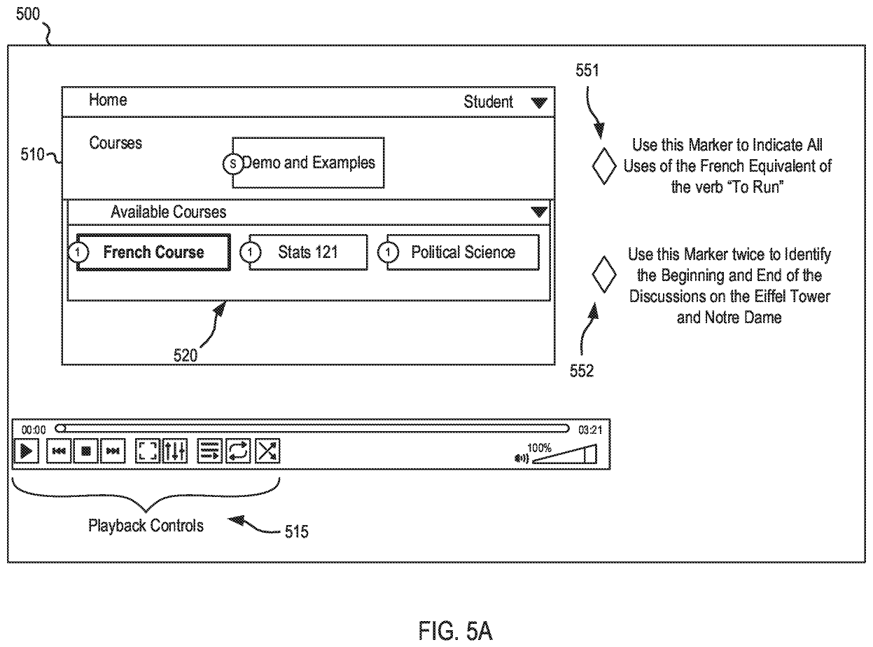

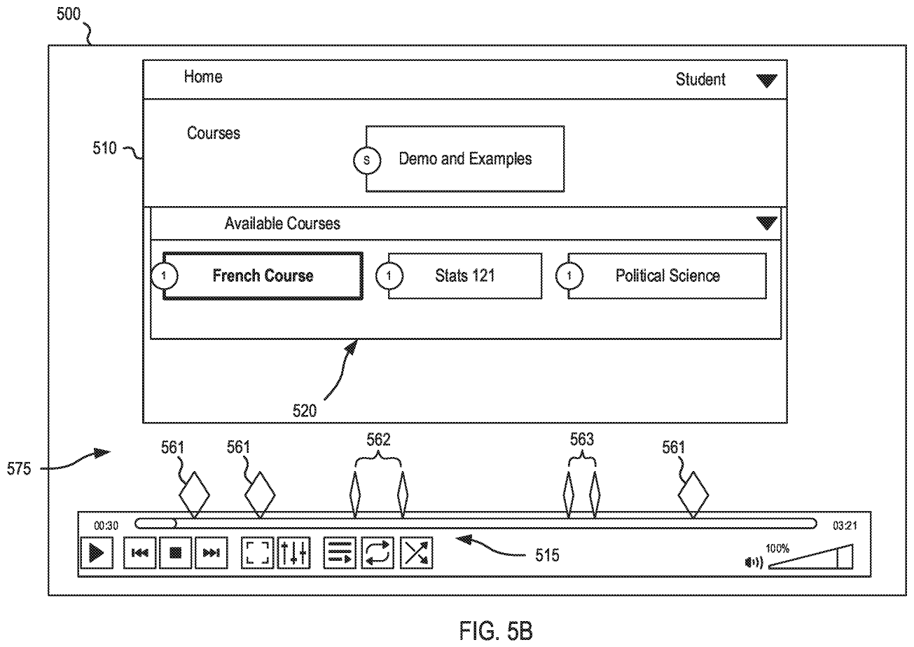

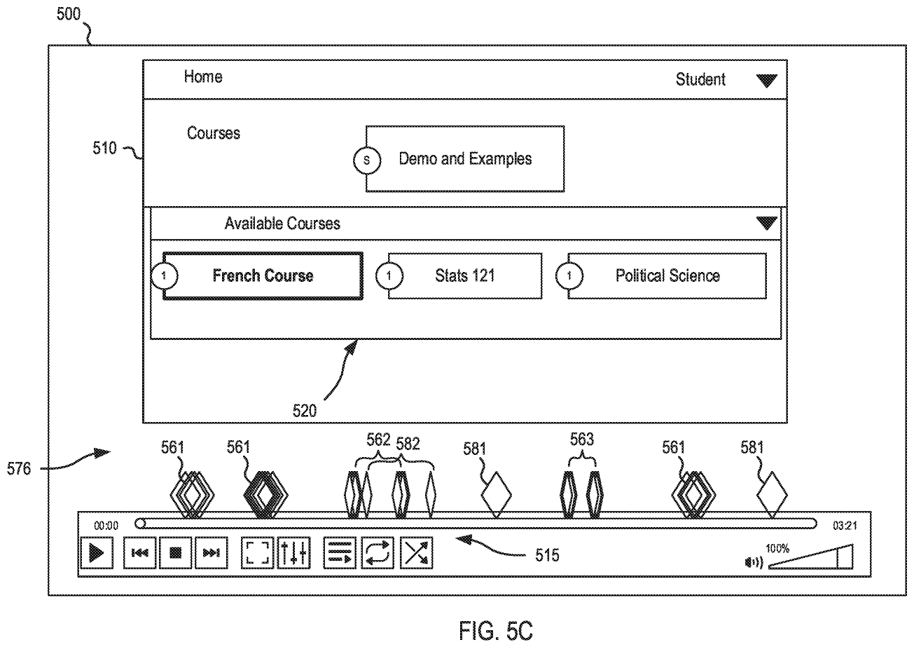

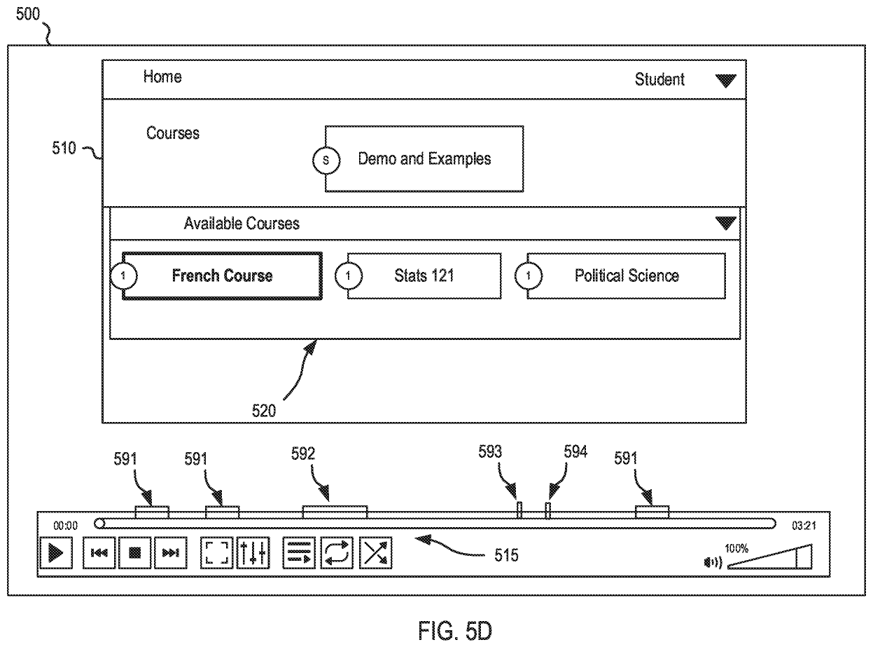

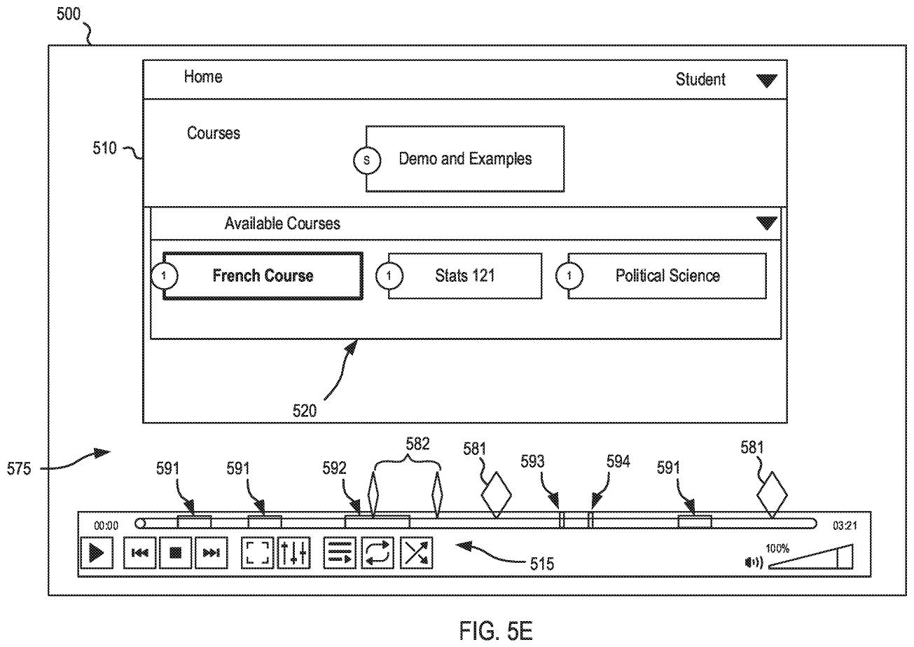

FIG. 5A illustrates an example of an interactive user interface 500 for presenting a video annotation instructional unit soliciting student answers in the form of markers 551 and 552, according to one embodiment. In the illustrated example, a video playback window 510 allows a student to select a French course 520. Playback controls 515 allow the student to control the presentation of the French course 520 and may include video playback features such as play, pause, rewind, fast forward, skip forward, skip backward, repeat, full screen, audio controls, brightness, playback speed, and the like.

As illustrated, the student may be instructed to place a shaded marker 551 at each location on the timeline (above the playback controls) at each location in which the French equivalent of the verb “to run.” The student may be further instructed to place white markers 552 at the beginning and end of the discussions of the Eiffel Tower and Notre Dame. As illustrated, the markers 551 and 552 may be in the form of icons (as illustrated) that are intended for placement on a video playback timeline.

In alternative embodiments, a marker may be represented by an image, a drawing, text, audio, or other data object presented on the student computing device. Video annotation instructional units may include any number of markers with instructions for each different type of marker indicating how and where the student should place the marker. According to various embodiments, a student may activate or place a marker by clicking, typing, speaking, or providing another input at any point during the playback of the video.

FIG. 5B illustrates the interactive user interface 500 of FIG. 5A with student answers 575 from a single student, according to one embodiment. Shaded markers 561 are placed in three locations in which the student identified the French equivalent for the verb “to run” during the video playback. White markers 562 and 563 are placed at the beginning and end of the portions of the video during which the student identified discussions of the Eiffel Tower and Notre Dame. The white markers 562 may be referenced to the Eiffel Tower discussion, and the white markers 563 may be referenced to the Notre Dame discussion.

FIG. 5C illustrates the interactive user interface 500 displaying student answers 576 from multiple students to a grader, according to one embodiment. As illustrated, numerous shaded markers 561 are shown indicating the various locations at which students identified the French equivalent of the verb “to run.” Similarly, multiple video segments are identified as corresponding to the Eiffel Tower and Notre Dame discussions via white markers 562. The illustrated examples include incorrect shaded student answer marks 581 and incorrect white student answer marks 582.

FIG. 5D illustrates the interactive user interface 500 facilitating the creation of grade rules via start time and/or stop time marks 591, 592, 593, and 594 for automatic application to student answers markers, according to one embodiment. In the illustrated example, grade rules 591 indicate acceptable timestamp ranges for identification of the French equivalent of the verb “to run.” The teacher, or another grader, may identify a specific time for each correct answer and an acceptable deviation. For instance, the first instance of the French equivalent of the verb “to run” may occur exactly 31 seconds into the video. The grader (or the system by default) may specify that answers within 2 seconds are acceptable. The grade rule may be associate with a score and/or other feedback. In some instances, a grader may identify a marker for a partially correct answer and associate appropriate feedback therewith.

In the illustrated example, the grade rule 592 may define a segment of the video during which a discussion of the Eiffel Tower takes place. The grade rule 592 may specify that the start and stop times identified by the student must be within the specified range for the grade rule to apply. Another grade rule includes the marks 593 and 594 that specify the specific start time (mark 593) and specific stop time (mark 594) of the discussion of Notre Dame during the video. The grade rule with marks 593 and 594 may require that the student answer marks must include start and stop times within the respective start time marks 593 and the specific stop time mark 594.

Automatic grading of student answers to a video annotation instructional unit is driven by one or more grade rules. Each student answer mark may be evaluated to determine which, if any, grade rule applies. Grade rules are considered “triggered” when a student answer mark associated within a specific video annotation instructional unit satisfies the applicability criteria of the grade rule. Pseudocode may be used to express the applicability as follows:

Rule.startTime<=Mark.videoTime<=Rule.endTime

And

Rule.markerId==Mark.markerId

When a grade rule is triggered, the score and/or feedback of the grade rule is associated with the student answer mark. In some instances, a given student answer mark may trigger one grade rule, multiple grade rules, or none of the grade rules of a particular video annotation instructional unit. In some embodiments, the teacher, or another grader, may define a default grade rule for a video annotation unit, which is triggered by any student answer mark that does not trigger any other grade rule associated with the video annotation unit.

Grade rules may be created during the creation of the video annotation instructional unit. Alternatively, grade rules may be created at a later time and/or by a different entity. For example, a teacher may create grade rules after student answers have been received. One advantage of this approach is that a grader can create grade rules that apply to actual student answer marks and provide scores and feedback in the context of the collective student answer marks.

As previously described, the start and end video times for a grade rule may be specified by a single event. That is, the grader may specify an exact time in the video for a “correct answer” (or a wrong answer), and the system may add a default padding time to create start and end video times for the grade rule. When the range specification event occurs, the current play head video time is saved. The start and end times of the grade rule may be expressed in terms of pseudocode as:

StartTime=playHeadTime−paddingTime

EndTime=playHeadTime+paddingTime

FIG. 5E illustrates the interactive user interface 500 with the remaining ungraded shaded student answer marks 581, and ungraded white student answer marks 582 after automatic application of the grade rules defined by marks 591, 592, 593, and 594, according to one embodiment. The illustrated visualization allows the teacher, or another grader, to visualize student answer marks that did not trigger an existing grade rule. By way of example, the teacher may create a new grade rule that identifies the white marks 582 as incorrectly identifying the segment of the video that includes a discussion of the Eiffel tower. The teacher may, for example, associate a score of zero with the grade rule and feedback explaining to the student or students that the start mark is within the discussion, but that the stop mark is outside of the acceptable range. Similarly, the teacher may create grade rules indicating that the shaded student answer marks 581 are incorrect. As each new grade rule is created, the student answer marks that trigger the new grade rule may be removed from the visualization.

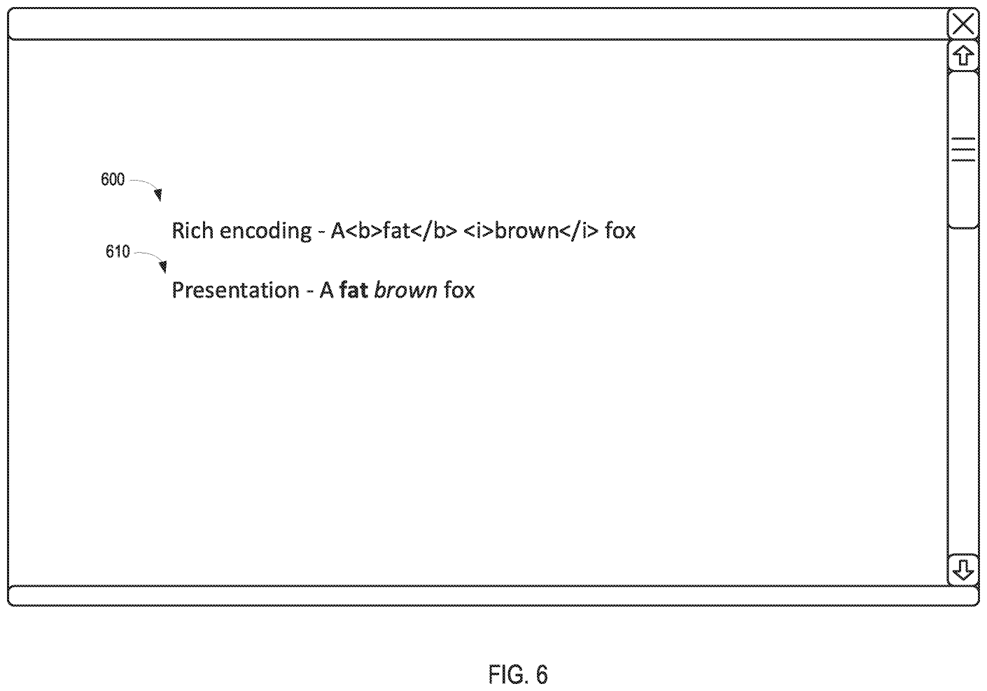

FIG. 6 illustrates an example of a rich string encoding 600 and a possible presentation 610, according to one embodiment. As previously noted, rich strings have additional embedded information to identify the content of portions of a string, to control the presentation of the content, and/or identify edits made to the strings. In the illustrated embodiment, tags are used to identify a portion of the string for bold display and another portion for display in italics.

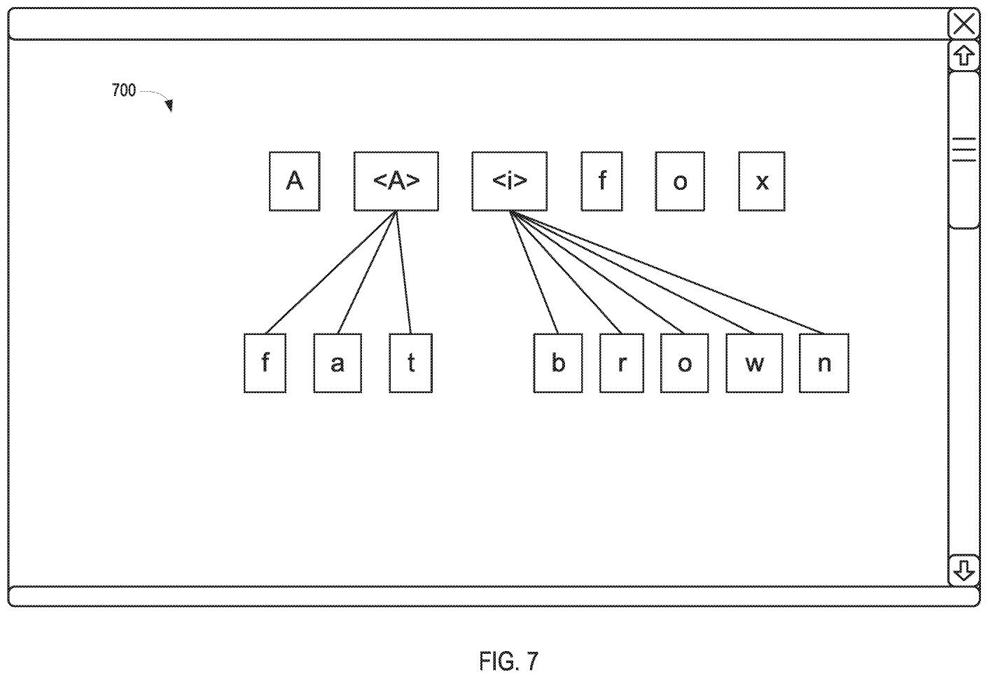

FIG. 7 illustrates a rich string tree 700 representation of the rich string from FIG. 7, according to one embodiment. A rich string tree 700 can generally be created when control codes of a rich string occur in pairs (as in HTML). As previously noted, the Domain Object Model (DOM) used to manipulate HTML in many web browsers is an example of a rich string tree.

A “path reference” may be used in conjunction with rich string trees, which can be used to locate a character within the tree. A path reference can be expressed as a sequence of references where each reference locates a node in the tree and subsequent references refer to the sub-tree. For example, the path reference [2,1] can be applied to the rich string tree 700 to reference the character “r.” The “2” references the <i> node at the top of the tree, and the “1” references the “r” node inside of the <i> node.

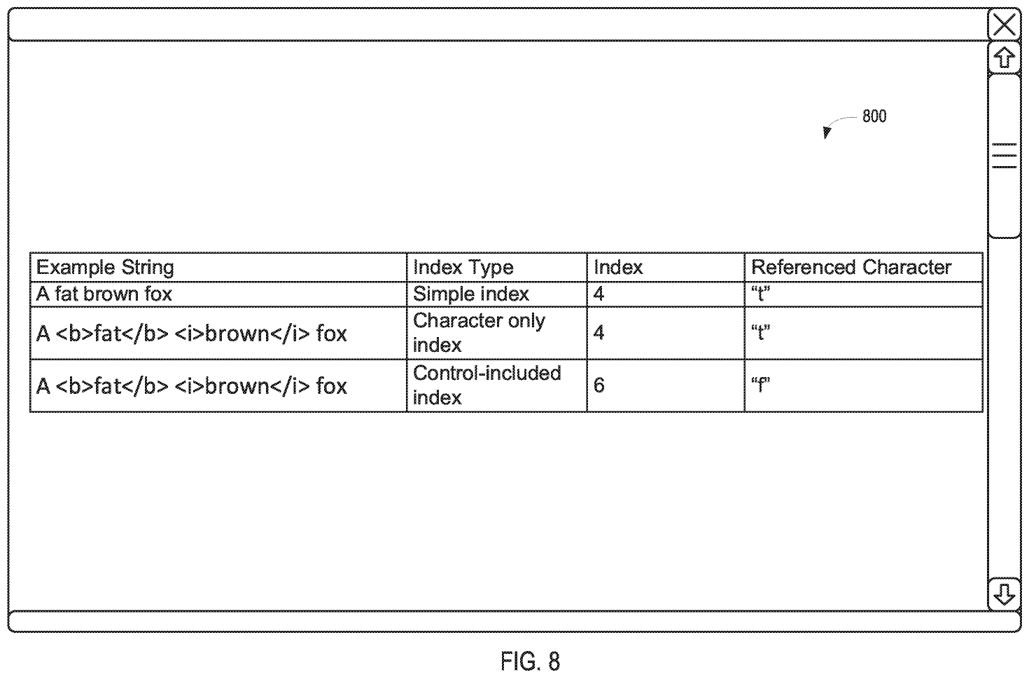

FIG. 8 illustrates some examples of types of string index references 800, according to one embodiment. The first row of the table includes column titles. The second row provides a simple index type for the string “A fat brown fox” as having an index value of 4 with a referenced character of “t” because the “t” is the fourth character in the string.

The third row includes a character-only index of a rich text string with bolded and italicized paired tags. Again, the index value of 4 corresponds to the referenced character “t” because the index type is “character only index.” The fourth row is a control-included index such that the index value of 6 for the same string corresponds to the referenced character “f.”

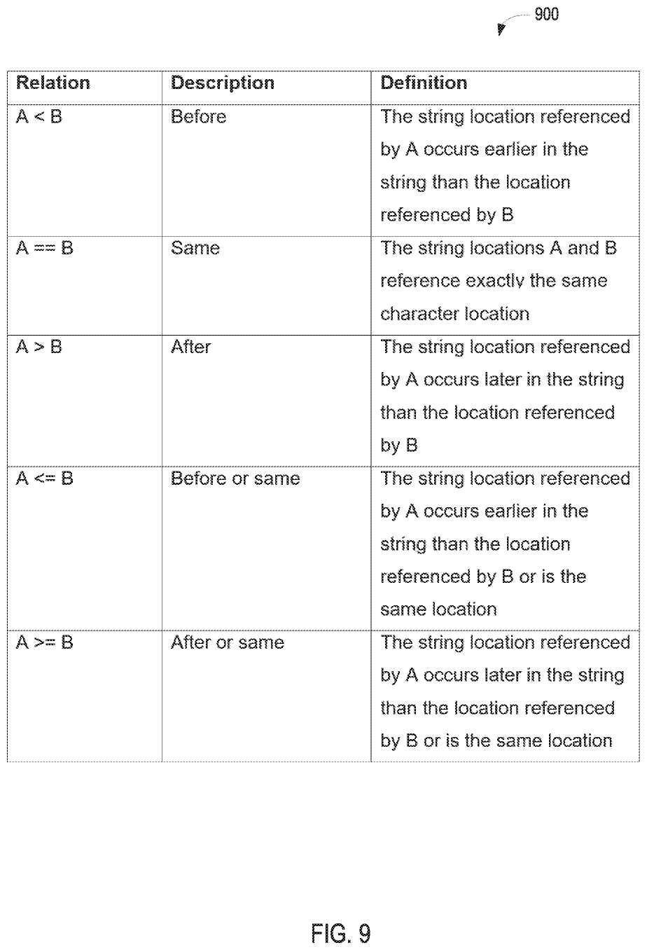

FIG. 9 illustrates a table 900 of various relationships for comparing two references. The assessment system may utilize various algorithms to compare selections and apply edits and feedback correctly. Relationships in the first column define various relationships between references “A” and “B.” The definitions in the third column are self-explanatory and correspond to standard operators in mathematical equations and are described in the second column.

FIG. 9 merely provides example relationships, and it is appreciated that additional relationships may be defined and/or employed in one or more matching algorithms for grading, feedback assignment, and/or identifying or applying edits. For example, a relationship “/” may be used to define a relationship in which the string location referenced by A is located within four characters of the string location referenced by B. Operators for wildcards, Excludes ( ), AND, OR, Groups ( ), Around ( ), etc. may also be defined by default in the system and/or through user customization.

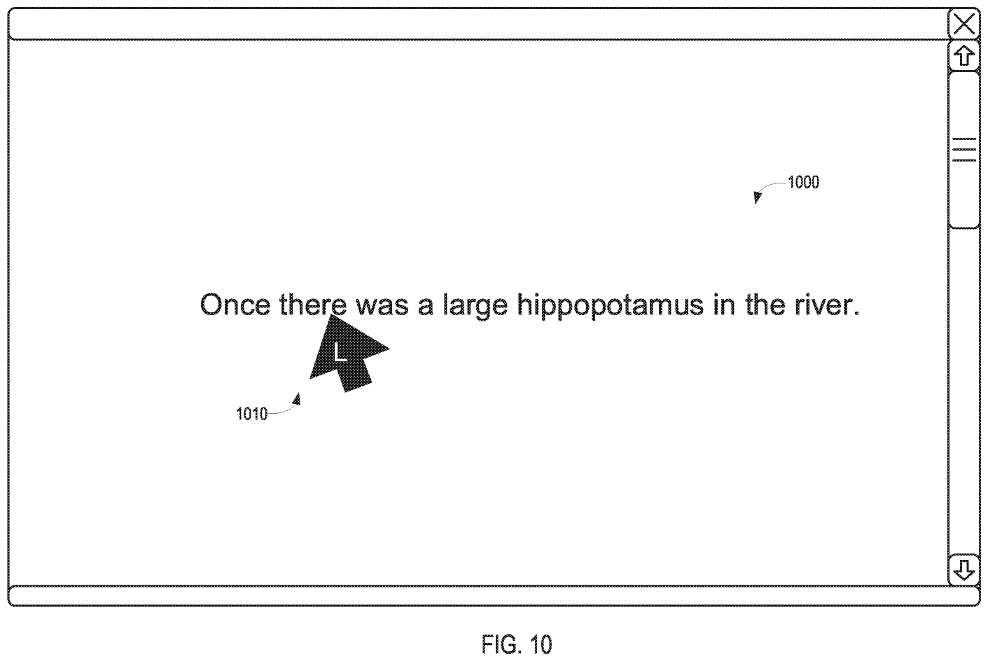

FIG. 10 illustrates the presentation of a string 1000 with a selection 1010 at the location indicated by the arrow at point L that can be encoded as a string location reference, according to one embodiment. When a student or other assessee interacts with a string through a user interface (e.g., touch screen, browser window, tablet, mobile phone, etc.), the system allows for a location selection. A selection is an interactive behavior that specifies either (i) a string location reference or (ii) a string location range. A string location range comprises a pair of string location references [A,B] such that A<=B where the range specifies all character locations C such that A<=C and C<B. A single string location reference A can also be represented by a range [A,A].

In FIG. 10, the system may translate the selection 1010 of location L into the index range [9,9] in the example. String Location L can be expressed by a mouse, a trackball, an electronic pen, a touch sensor, or any other locator device. A selection location may also be modified by arrow keys to move forward or backward through the string references. Using any of a wide variety of methods for selection, the user may select a single point and/or a range selection via the GUI. Given a range, R=[A,B], we can use the notation R.start to reference the location A and R.end to reference the location B.

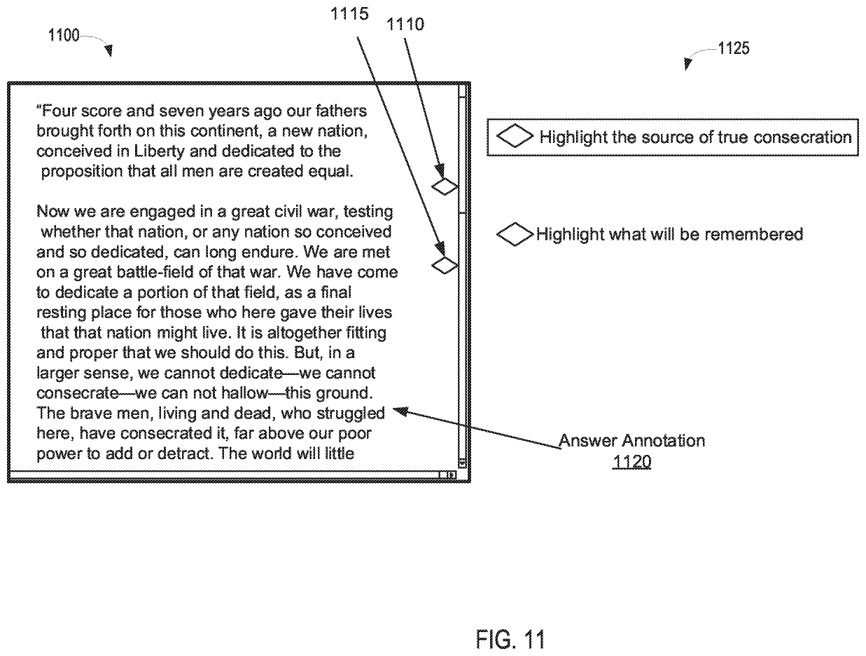

FIG. 11 illustrates an example of a text annotation instructional unit 1100 with a segment of text in the window and markers 1110 and 1115 that a student can use to answer questions or challenge problems. In the illustrated example, the student is instructed to read the passage and place the first, shaded marker proximate the portion of text that identifies the “source of true consecration,” and the second, white marker proximate the portion of text that describes “what will be remembered.”

A text annotation instructional unit 1100 may provide the student with an interactive user interface that includes a scrolling window of text, one or more markers, answer highlights 1120, and a problem presentation. The markers 1110 and 1115 may be visually displayed and/or include drawings, text, audio, etc. The information associated with the marker may instruct the student as to what the student should do with the marker (e.g., marker instructions 1125). In various examples, the student may select the marker by, for example, clicking or tapping on it, and then moving it to a selected location to form a student answer. In one example, the GUI may instruct the student to use a key on the left side of a keyboard to indicate when a democratic candidate begins speaking and select a key on the right side of the keyboard to indicate when a republican candidate begins speaking. The key presses may cause markers to appear that can be visually confirmed and/or manipulated by the student to form an answer.

According to various embodiments, a student answer to a text annotation instructional unit may include one or more marks that are displayed, for example, on or proximate a scroll bar of the displayed text. The starting and ending positions of the string location range may be derived from the start and end position of the student's interactive text selection. The marker identifier may be derived from the selected marker at the time that the student selects the text.

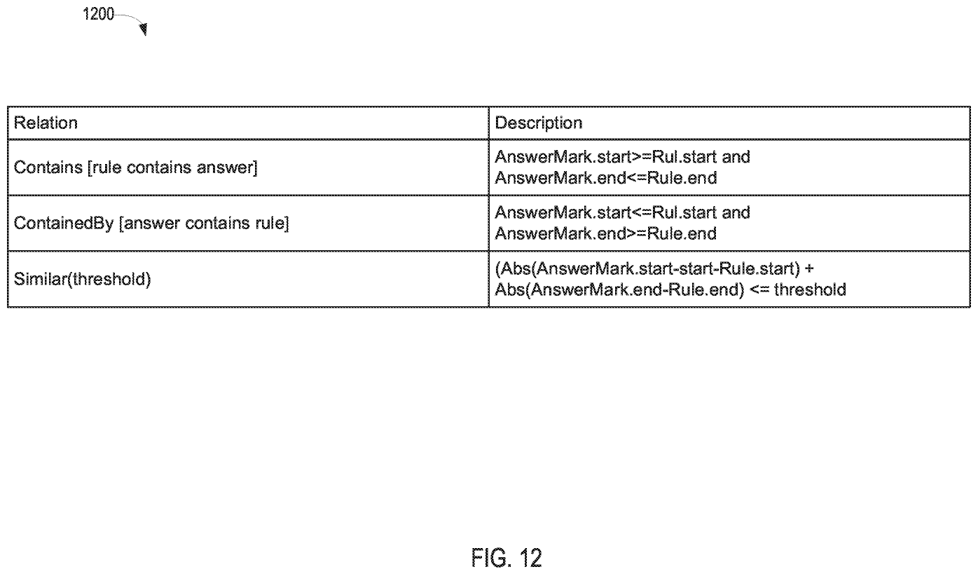

FIG. 12 illustrates an example table 1200 of range relationships to define the applicability of grader answers to student answers, according to one embodiment. As previously described, the system may automatically or semi-automatically grade student answers to challenge problems. A teacher or other user may create a grade rule, as described herein, that identifies a string location range, a range relationship, a score, and/or other feedback. A grade rule may be associated with a particular text annotation instructional unit.

As illustrated, the range relationship defines how a grade rule is to be applied to student answers. As illustrated, a “contain” relationship indicates that a grade rule defined in terms of a rule start point and rule end point applies when the student answer's start and end points are contained or within the rules start and end points. In contrast, a “contains b” relationship applies when the answer's start and stop points encompass the start and stop points of the rule. Finally, a “similar” relationship may be used to apply a grade rule to answers that include start and stop points within a threshold range of the start and stop points of the rule.

As previously described, a grade rule is “triggered” based on a determination that the grade rule's selection range and the student answer mark's selection range satisfy the specified relationship. When a grade rule is triggered, the rule's score and feedback are associated with the student answer. In some instances, multiple rules may be triggered by a single student answer. In some embodiments, a user may define a default grade rule for a text annotation instructional unit, which is triggered by any student mark that does not trigger any other grade rules specified for the text annotation instructional unit.

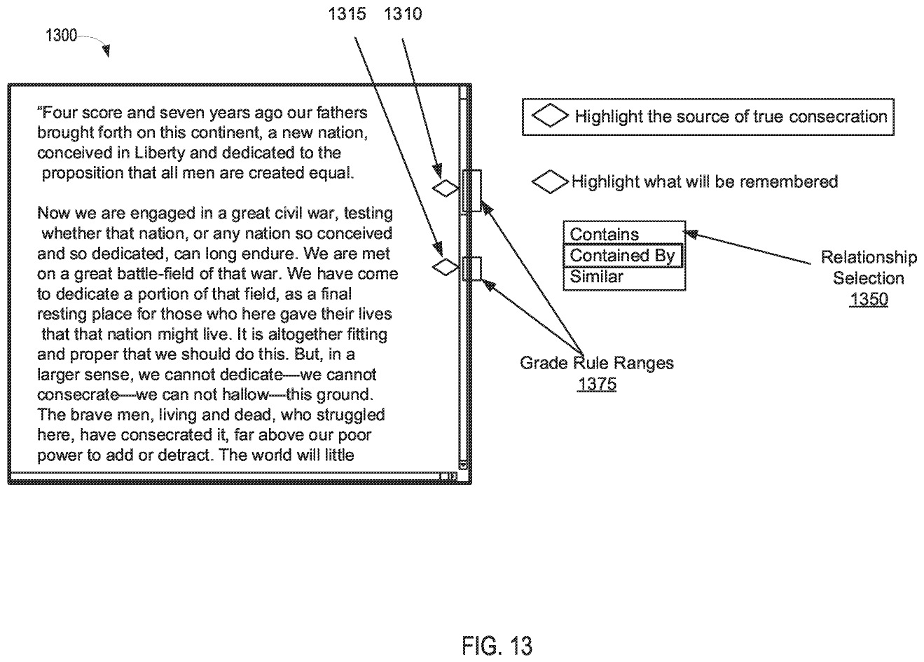

FIG. 13 illustrates an example of a GUI 1300 for a teacher or another grader to specify grade rules in terms of feedback and relationship applicability, according to one embodiment. Grade rule ranges 1375 may be specified for student answer markers 1310 and 1315. The GUI 1300 may allow the user to select a relationship from a dropdown menu 1350 and/or create a custom relationship to define how a given grade rule is to be applied to student answer markers 1310 and 1315.

In various embodiments, the feedback associated with a grade rule can be created by any of a wide variety of tools for editing pictures, drawings, images, text, HTML, audio, video, or other data objects that can be presented to the student. In some instances, grade rules may be created at the same time as the text annotation instructional unit and/or by the same creative entity. In other instances, the grade rules may be created later in time, in response to student answers, and/or by a different entity than the entity that created the related text annotation instructional unit.

In some instances, a user may create grade rules after student answers have been received to efficiently create grade rules that apply to the specific answer students generate—rather than guessing at what answers might be provided.

A grade rule specification system may include an interactive computer user interface (e.g., a GUI) that allows a user to specify a selection location range, a marker identifier (implicitly or explicitly), a score, and/or associated feedback. In some embodiments, a teacher, or another grader, may associate a marker with start and stop points defined with respect to the text and assign feedback thereto. The teacher may then associate a relationship with the grade rule defining the manner in which the grade rule should be applied to student answer marks made with respect to text annotation instructional units. In one example, the system may create a grade rule data object in response to a teacher interactively using the GUI to select a portion of text in the text window, associate feedback therewith, and select a relationship for application to student answers.

As illustrated, the range of a grade rule may be visually displayed proximate the scroll bar for the text. If student answers have already been received by the system (as illustrated with student answers in the form of answer markers 1310 and 1315), the mark points of all such answers may be displayed on the scrollbar. The system may remove all student answer marks that match an already existing grade rule. The removal of already graded student answer marks may make it easier for the grader to visualize the remaining ungraded student answer marks and create additional grade rules that are applicable thereto. In some embodiments, already graded student answer marks may be changed in appearance relative to the ungraded student answer marks instead of being completely removed. For example, a transparency level of the already graded marks may be increased to emphasize the ungraded marks.

This disclosure has been provided in the context of numerous examples and variations, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. The scope of the present disclosure should, therefore, be interpreted to encompass at least the following claims:

1. A recursive royalty system to manage royalty distributions for electronic books (eBooks) dynamically assembled from instructional units with nested ownership, comprising:
a rendering subsystem to render an eBook for display on a digital electronic display for viewing by a user, wherein the eBook is assembled from a plurality of instructional units that are owned by a plurality of owners;
an ownership share subsystem to:
calculate a curation fraction value (CFV) for an assembly owner of the assembled eBook, and
generate an owner value profile (OVP) data object that associates a calculated value of each instructional unit with the owner thereof; and
a royalty distribution subsystem to compute a distribution portion for a royalty received for the assembled eBook based on the CFV of the assembly owner and the OFP values of the identified unit owners of the instructional units.

2. A non-transitory computer readable medium with instructions stored thereon that, when executed by a processor of a computing device, cause the computing device to implement operations to manage royalty distributions for dynamically assembled electronic books (eBooks), the operations comprising:
identify an assembled eBook that comprises a plurality of instructional units owned by a plurality of owners;
associate a curation fraction value (CFV) of the eBook with an assembly owner of the assembled eBook;
identifying a unit owner associated with each instructional unit, wherein each identified unit owner owns at least one of the instructional units;
compute a value unit of each of the instructional units;
generate an owner value profile (OVP) data object for the assembled eBook, wherein the OVP data object associates each identified unit owner with a value sum, wherein the value sum associated with each unit owner comprises the sum of the computed value units of the instructional units owned by each respective unit owner;
calculate an owner fraction profile (OFP) value for each identified unit owner, wherein the OFP value of each unit owner is calculated based on the value sum associated with each respective identified unit owner divided by the total of all the computed value units; and
compute a distribution portion for a royalty received for the assembled eBook based on the CFV of the assembly owner and the OFP values of the identified unit owners of the instructional units.

3. The non-transitory computer-readable medium of claim 2, wherein the value unit of each instructional unit is computed based on one or more of: a number of characters, a number of words, a number of graphical displays, a length, and a duration.

4. The non-transitory computer-readable medium of claim 2, wherein the value unit of each instructional unit is computed based on a number of pixels in the instructional unit.

5. The non-transitory computer-readable medium of claim 2, wherein at least one of the instructional units comprises an embedded eBook that comprises a compilation of nested instructional units, and wherein the operations further comprise:
assign the identified unit owner of the embedded eBook as a nested assembly owner of the embedded eBook;
associate a nested CFV of the embedded eBook with the nested assembly owner;
generate a nested OVP data object for the embedded eBook;
calculate a nested OFP value for each owner of the nested instructional units; and
compute a nested distribution of the distribution portion for the identified unit owner of the embedded eBook based on the nested CFV and the nested OFPs of the owners of the nested instructional units.

6. The non-transitory computer-readable medium of claim 2, wherein at least one of the instructional units comprises one or more of: text, a video clip, an audio clip, a drawing, a graph, a chart, a challenge problem, and an image.

7. The non-transitory computer-readable medium of claim 2, wherein the operations further comprise:
calculate a usage metric of each instructional unit by a user of the eBook, and wherein the value unit of each instructional unit is computed based on a relative usage of each respective instructional unit relative to the usage of the other instructional units.

8. The non-transitory computer-readable medium of claim 7, wherein at least one of the instructional units comprises a challenge problem and the usage metric for the challenge problem is based on a measured amount of time the user spends interacting with the challenge problem.

9. The non-transitory computer-readable medium of claim 7, wherein each usage metric indicates whether the user has opened each respective instructional unit or not.

10. The non-transitory computer-readable medium of claim 7, wherein each usage metric corresponds to an accumulation of time from a plurality of time intervals during which each respective instructional unit is (i) visible to the user and (ii) during which an interaction by the user is detected.

11. A system to manage royalty distributions for dynamically assembled electronic books (eBooks), comprising:
a digital library that includes an eBook assembled to include a plurality of instructional units owned by a plurality of owners;
a curation fraction value (CFV) subsystem to calculate a CFV for an assembly owner of the assembled eBook;
an owner value profile (OVP) subsystem to:
identify a unit owner associated with each instructional unit, wherein each identified unit owner owns at least one of the instructional units of the assembled eBook,
compute a value unit of each of the identified instructional units, and
generate an OVP data object for the assembled eBook,
wherein the OVP data object associates each identified unit owner with a value sum, wherein the value sum associated with each unit owner comprises the sum of the computed value units of the instructional units owned by each respective unit owner;
an owner fraction profile (OFP) subsystem to calculate an OFP value for each identified unit owner, wherein the OFP value of each unit owner is calculated based on the value sum associated with each respective identified unit owner divided by the total of all the computed value units; and
a royalty distribution subsystem to compute a distribution portion for a royalty received for the assembled eBook based on the CFV of the assembly owner and the OFP values of the identified unit owners of the instructional units.

12. The system of claim 11, wherein at least one of the instructional units comprises an embedded eBook that comprises a compilation of nested instructional units;
wherein the OVP subsystem is further configured to:
recursively assign the identified unit owner of the embedded eBook as a nested assembly owner of the embedded eBook, and
generate a nested OVP data object for the embedded eBook;
wherein the CFV subsystem is further configured to associate a nested CFV of the embedded eBook with the nested assembly owner;
wherein the OFP subsystem is further configured calculate a nested OFP value for each owner of the nested instructional units; and
wherein the royalty distribution subsystem is further configured to compute a nested distribution of the distribution portion for the identified unit owner of the embedded eBook based on the nested CFV and the nested OFPs of the owners of the nested instructional units.

13. The system of claim 11, wherein the OVP subsystem is further configured to compute the value unit of each instructional unit based on one or more of: a number of characters, a number of words, a number of graphical displays, a length, and a duration.

14. The system of claim 11, wherein the OVP subsystem is further configured to compute the value unit of each instructional unit based on a number of pixels in the instructional unit.

15. The system of claim 11, wherein at least one of the instructional units comprises one or more of: text, a video clip, an audio clip, a drawing, a graph, a chart, a challenge problem, and an image.

16. The system of claim 11, further comprising a usage metric subsystem to determine a usage metric of each instructional unit by a user of the eBook, and wherein the OVP subsystem is configured to compute the value unit of each instructional unit based on the determined usage metric associated with each respective instructional unit.

17. The system of claim 16, wherein at least one of the instructional units comprises a challenge problem and the usage metric for the challenge problem is based on a measured amount of time the user spends interacting with the challenge problem.

18. The system of claim 16, wherein each usage metric indicates whether the user has opened each respective instructional unit or not.

19. The system of claim 16, wherein each usage metric is based, at least in part, on an amount of time each respective instructional unit is caused to be displayed on an electronic display by the user.

20. The system of claim 16, wherein each usage metric corresponds to an accumulation of time from a plurality of time intervals during which each respective instructional unit is (i) visible to the user and (ii) during which an interaction by the user is detected.
